(19) United States
(12) Patent Application Publication
(10) Pub. No.: US 2024/0406850 A1
(43) Pub. Date: Dec. 5, 2024

(54) COMMUNICATION METHOD AND COMMUNICATION APPARATUS

(71) Applicant: HUAWEI TECHNOLOGIES CO., LTD., Shenzhen (CN)

(72) Inventors: Jun WANG, Hangzhou (CN); Xiaolu WANG, Hangzhou (CN); Xian MENG, Hangzhou (CN); Dali QIN, Hangzhou (CN); Hejia LUO, Hangzhou (CN); Yu WANG, Hangzhou (CN); Tianhang YU, Hangzhou (CN); Rong LI, Boulogne Billancourt (FR)

(21) Appl. No.: 18/802,136

(22) Filed: Aug. 13, 2024

Related U.S. Application Data
(63) Continuation of application No. PCT/CN2023/074983, filed on Feb. 8, 2023.

(30) Foreign Application Priority Data
Feb. 14, 2022 (CN) 202210133059.2

(51) Int. Cl. H04W 48/16; H04W 48/14

(52) U.S. Cl. CPC H04W 48/16; H04W 48/14

(57) ABSTRACT

The present disclosure relates to communication methods and communication apparatuses. In one example method, a first communication apparatus receives first configuration information, where the first configuration information includes first identification update information and information about a first update moment of a first cell of a second communication apparatus, and the first identification update information is used to determine first identification information used by the first cell at the first update moment or after the first update moment. The first communication apparatus communicates based on the first configuration information by using the first identification information at the first update moment or after the first update moment, where the first communication apparatus is in a coverage range of the first cell.

### CROSS-REFERENCE TO RELATED APPLICATIONS

This application is a continuation of International Application No. PCT/CN2023/074983, filed on Feb. 8, 2023, which claims priority to Chinese Patent Application No. 202210133059.2, filed on Feb. 14, 2022. The disclosures of the aforementioned applications are hereby incorporated by reference in their entireties.

### TECHNICAL FIELD

Embodiments of this application relate to the field of communication technologies, and more specifically, to a communication method and a communication apparatus.

### BACKGROUND

A satellite communication network is a communication network in which a large-scale constellation including a specific quantity of low-orbit earth satellites provides a satellite-to-ground communication service for a terminal device. For example, the large-scale constellation may include tens of thousands of low-orbit earth satellites. Assuming that a coverage area of one low-orbit earth satellite is planned as one cell, and a physical cell identifier (physical cell identifier, PCI) of one cell is associated with one low-orbit earth satellite, there are tens of thousands of cells, and there are a plurality of cells having a same PCI in the tens of thousands of cells.

With the movement of the low-orbit earth satellite and the change of the coverage area, a PCI of a same location is changed when the location is covered by different low-orbit earth satellites. PCIs of a plurality of neighboring cells may be the same, and this may cause some problems. For example, when two or more neighboring cells of a cell on which the terminal device camps have a same PCI, a network device cannot correctly hand over the terminal device from the cell on which the terminal device camps to a target neighboring cell.

Therefore, how to avoid cell identifier confusion or a cell identifier conflict between neighboring cells in a large-scale constellation communication system is an urgent technical problem to be resolved.

### SUMMARY

Embodiments of this application provide a communication method and a communication apparatus, to resolve a problem of cell identifier confusion or a cell identifier conflict between neighboring cells in a large-scale constellation communication system.

According to a first aspect, a communication method is provided, and includes: A first communication apparatus receives first configuration information, where the first configuration information includes first identification update information and information about a first update moment of a first cell of a second communication apparatus, and the first identification update information is used to determine first identification information used by the first cell at the first update moment or after the first update moment. The first communication apparatus communicates based on the first configuration information by using the first identification information at the first update moment or after the first update moment, where the first communication apparatus is in a coverage range of the first cell.

The first update moment may be a moment at which a cell that has a same identifier as the first cell becomes a neighboring cell of the first cell, or may be a moment before the moment at which the cell that has the same identifier as the first cell becomes the neighboring cell of the first cell. The first identification update information may be used to determine the first identification information used by the first cell at the first update moment or after the first update moment.

A moment at which the first communication apparatus communicates by using the first identification information may be the moment before the moment at which the cell that has the same identifier as the first cell becomes the neighboring cell of the first cell, or may be the moment at which the cell that has the same identifier as the first cell becomes the neighboring cell of the first cell.

Identification information of the first cell is updated at or before the moment at which the cell that has the same identifier as the first cell becomes the neighboring cell of the first cell, so that a network device can distinguish between the first cell and the neighboring cell of the first cell based on identification information of different cells, to avoid a cell identifier conflict or cell identifier confusion between the first cell and the neighboring cell, and avoid a problem such as a cell handover failure caused by the cell identifier conflict or the cell identifier confusion.

In a possible implementation, the first identification information includes a physical cell identifier PCI.

A PCI of the first cell is updated at or before a moment at which a cell that has a same PCI as the first cell becomes the neighboring cell of the first cell, so that PCI confusion or a PCI conflict between the first cell and the neighboring cell can be avoided.

In a possible implementation, the first identification information further includes at least one of a frequency and a polarization direction.

At least one of the frequency and the polarization direction of the first cell is updated at or before a moment at which a cell that has a same cell identifier as the first cell becomes the neighboring cell of the first cell, so that the first cell and the neighboring cell can be distinguished from each other based on a fact that the cells are different in at least one of the frequency and the polarization direction. In this way, a conflict between a plurality of neighboring cells having a same cell identifier can be avoided, and a cell handover failure caused by the cell identifier conflict or cell identifier confusion can be avoided.

In a possible implementation, the first identification update information includes the first identification information.

The first identification update information includes the first identification information, in other words, the first identification update information includes updated identification information, so that a terminal device can directly obtain the updated identification information of the first cell.

In a possible implementation, the first identification update information includes a difference between the first identification information and identification information that is used by the first cell before the first update moment.

The difference between the first identification information and the identification information that is used by the first cell before the first update moment is indicated, so that signaling overheads can be reduced.

In a possible implementation, the information about the first update moment includes timer information corresponding to the first update moment or standard time corresponding to the first update moment.

The standard time or a timer indicates a moment at which the identification information of the first cell is updated or changed, so that in this embodiment of this application, a moment at which identification information of a cell is updated or changed can be accurately indicated.

In a possible implementation, the first configuration information further includes third identification update information and information about a third update moment of the first cell. The third identification update information is used to determine third identification information used by the first cell at the third update moment or after the third update moment.

Identification update information corresponding to a plurality of moments is configured in the first configuration information, so that in this embodiment of this application, a plurality of pieces of identification update information in a period of time can be determined by using one piece of configuration information. In this way, frequently sending the configuration information for a plurality of times can be avoided, and signaling resources can be saved.

In a possible implementation, the method further includes: The first communication apparatus receives second configuration information, where the second configuration information includes second identification update information and information about a second update moment of a second cell, the second identification update information is used to determine second identification information used by the second cell at the second update moment or after the second update moment, and the second cell is a neighboring cell of the first cell. The first communication apparatus communicates with a first communication apparatus of the second cell based on the second configuration information by using the second identification information at the second update moment or after the second update moment.

In the foregoing possible implementation, after receiving the second configuration information, the first communication apparatus in the coverage range of the first cell may use the updated identification information to measure the neighboring cell (the second cell) and communicate with a network device corresponding to the neighboring cell.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second cell is a first-order neighboring cell of the first cell; or the second cell is a second-order neighboring cell of the first cell.

According to a second aspect, a communication method is provided, and includes: A second communication apparatus determines first configuration information of a first cell of the second communication apparatus, where the first configuration information includes first identification update information and information about a first update moment of the first cell, and the first identification update information is used to determine first identification information used by the first cell at the first update moment or after the first update moment. The second communication apparatus sends the first configuration information.

A network device predicts a time-varying characteristic of a neighboring cell relationship in a non-terrestrial network by using ephemeris information of a satellite device, determines, based on the time-varying characteristic, a moment at which two cells that have a same identifier become neighboring cells, and then determines and sends the first configuration information, so that in this embodiment of this application, identification information of the first cell can be different from identification information of a cell that has a same identifier as the first cell, and the network device can distinguish between the first cell and a neighboring cell based on different identification information, to avoid a cell identifier conflict or cell identifier confusion between the first cell and the neighboring cell, and avoid a problem such as a cell handover failure caused by the cell identifier conflict or the cell identifier confusion.

In a possible implementation, the first identification information includes a physical cell identifier.

A PCI of the first cell is changed at or before a moment at which the cell that has a same PCI as the first cell becomes the neighboring cell of the first cell, so that PCI confusion or a PCI conflict between the first cell and the neighboring cell is avoided.

In a possible implementation, the first identification information further includes at least one of a frequency and a polarization direction.

At least one of the frequency and the polarization direction of the first cell is updated at a moment or before at which a cell that has a same cell identifier as the first cell becomes the neighboring cell of the first cell, so that the first cell and the neighboring cell can be distinguished from each other based on a fact that the cells are different in at least one of the frequency and the polarization direction. In this way, a conflict between a plurality of neighboring cells having a same cell identifier can be avoided, and a cell handover failure caused by the cell identifier conflict or cell identifier confusion can be avoided.

In a possible implementation, the first identification update information includes the first identification information.

The first identification update information includes the first identification information, in other words, the first identification update information includes updated identification information, so that a terminal device can directly obtain the updated identification information of the first cell.

In a possible implementation, the first identification update information includes a difference between the first identification information and identification information that is used by the first cell before the first update moment.

The difference between the first identification information and the identification information that is used by the first cell before the first update moment is indicated, so that signaling overheads can be reduced.

In a possible implementation, the information about the first update moment includes timer information corresponding to the first update moment or standard time corresponding to the first update moment.

The standard time or a timer indicates a moment at which the identification information of the first cell is updated or changed, so that in this embodiment of this application, a moment at which identification information of a cell is updated or changed can be accurately indicated.

In a possible implementation, the first configuration information further includes third identification update information and information about a third update moment of the first cell. The third identification update information is used to determine third identification information used by the first cell at the third update moment or after the third update moment.

Identification update information corresponding to a plurality of moments is configured in the first configuration information, so that in this embodiment of this application, a plurality of pieces of identification update information in a period of time can be determined by using one piece of configuration information. In this way, frequently sending the configuration information for a plurality of times can be avoided, and signaling resources can be saved.

In a possible implementation, that the second communication apparatus sends the first configuration information includes: The second communication apparatus sends the first configuration information to a first communication apparatus in a coverage range of the first cell. Alternatively, the second communication apparatus sends the first configuration information to a third communication apparatus corresponding to a second cell, where the second cell is a neighboring cell of the first cell.

The first configuration information is sent to a network device corresponding to the neighboring cell of the first cell, so that in this embodiment of this application, a terminal device in a coverage range of the neighboring cell of the first cell can measure the first cell by using the updated identification information, and communicate with a network device corresponding to the first cell.

In a possible implementation, the method further includes: The second communication apparatus receives second configuration information sent by the third communication apparatus corresponding to the second cell, where the second configuration information includes second identification update information and information about a second update moment of the second cell, and the second identification update information is used to determine second identification information used by the second cell at the second update moment or after the second update moment. The second communication apparatus sends the second configuration information to the first communication apparatus.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second cell is a first-order neighboring cell of the first cell; or the second cell is a second-order neighboring cell of the first cell.

According to a third aspect, a communication method is provided, and includes: A first communication apparatus receives second configuration information, where the second configuration information includes second identification update information and information about a second update moment of a second cell, the second identification update information is used to determine second identification information used by the second cell at the second update moment or after the second update moment, the second cell is a neighboring cell of a first cell, and the first communication apparatus is in a coverage range of the first cell. The first communication apparatus communicates with the first communication apparatus of the second cell based on the second configuration information by using the second identification information at the second update moment or after the second update moment.

The second configuration information is sent to a terminal device in the coverage range of the first cell, so that in this embodiment of this application, the terminal device in the coverage range of the first cell can measure the second cell by using updated identification information, and communicate with a network device corresponding to the second cell.

In a possible implementation, the second identification information includes a physical cell identifier PCI.

A PCI of the second cell is updated at or before a moment at which a cell that has a same PCI as the second cell becomes a neighboring cell of the second cell, so that PCI confusion or a PCI conflict between the second cell and the neighboring cell is avoided.

In a possible implementation, the second identification information further includes at least one of a frequency and a polarization direction.

In a possible implementation, the second identification update information includes the second identification information.

The second identification update information is equivalent to the second identification information, so that in this embodiment of this application, a terminal device can directly obtain the updated identification information of the second cell.

In a possible implementation, the second identification update information includes a difference between the second identification information and identification information that is used by the second cell before the second update moment.

The second identification update information is equivalent to the difference between the second identification information and the identification information that is used by the second cell before the second update moment, so that in this embodiment of this application, signaling overheads can be reduced.

In a possible implementation, the information about the second update moment includes timer information corresponding to the second update moment or standard time corresponding to the second update moment.

The standard time or a timer indicates a moment at which identification information of the second cell is updated or changed, so that in this embodiment of this application, a moment at which identification information of a cell is updated or changed can be accurately

In a possible implementation, the second configuration information further includes fourth identification update information and information about a fourth update moment of the second cell. The fourth identification update information is used to determine fourth identification information used by the second cell at the fourth update moment or after the fourth update moment.

Identification update information corresponding to a plurality of moments is configured in the second configuration information, so that in this embodiment of this application, a plurality of pieces of identification update information in a period of time can be determined by using one piece of configuration information. In this way, frequently sending the configuration information for a plurality of times can be avoided, and signaling resources can be saved.

According to a fourth aspect, a communication method is provided, and includes: A second communication apparatus obtains second configuration information, where the second configuration information includes second identification update information and information about a second update moment of a second cell, and the second identification update information is used to determine second identification information used by the second cell at the second update moment or after the second update moment. The second communication apparatus sends the second configuration information to a first communication apparatus, where the second communication apparatus corresponds to a first cell, and the first communication apparatus is in a coverage range of the first cell.

In a possible implementation, that a second communication apparatus obtains second configuration information includes: The second communication apparatus receives the second configuration information sent by a third communication apparatus corresponding to the second cell.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second configuration information further includes fourth identification update information and information about a fourth update moment of the second cell. The fourth identification update information is used to determine fourth identification information used by the second cell at the fourth update moment or after the fourth update moment.

According to a fifth aspect, a communication apparatus is provided. The communication apparatus may be used in the first communication apparatus in the first aspect. The communication apparatus may be a terminal device, an apparatus (for example, a chip, a chip system, or a circuit) in the terminal device, or an apparatus that can be used together with the terminal device.

In a possible implementation, the communication apparatus may include modules or units that one to one correspond to the methods/operations/steps/actions described in the first aspect. The modules or units may be hardware circuits, software, or may be implemented by a hardware circuit in combination with software.

In a possible implementation, the communication apparatus may include: a receiving unit, configured to receive first configuration information, where the first configuration information includes first identification update information and information about a first update moment of a first cell of a second communication apparatus, and the first identification update information is used to determine first identification information used by the first cell at the first update moment or after the first update moment; and a processing unit, configured to communicate based on the first configuration information by using the first identification information at the first update moment or after the first update moment, where the communication apparatus is in a coverage range of the first cell.

In a possible implementation, the first identification information includes a physical cell identifier.

In a possible implementation, the first identification information further includes at least one of a frequency and a polarization direction.

In a possible implementation, the first identification update information includes the first identification information.

In a possible implementation, the first identification update information includes a difference between the first identification information and identification information that is used by the first cell before the first update moment.

In a possible implementation, the information about the first update moment includes timer information corresponding to the first update moment or standard time corresponding to the first update moment.

In a possible implementation, the first configuration information further includes third identification update information and information about a third update moment of the first cell. The third identification update information is used to determine third identification information used by the first cell at the third update moment or after the third update moment.

In a possible implementation, the receiving unit is further configured to receive second configuration information, where the second configuration information includes second identification update information and information about a second update moment of a second cell, the second identification update information is used to determine second identification information used by the second cell at the second update moment or after the second update moment, and the second cell is a neighboring cell of the first cell. The processing unit is further configured to communicate with the first communication apparatus of the second cell based on the second configuration information by using the second identification information at the second update moment or after the second update moment.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second cell is a first-order neighboring cell of the first cell; or the second cell is a second-order neighboring cell of the first cell.

According to a sixth aspect, a communication apparatus is provided. The communication apparatus may be used in the second communication apparatus in the second aspect. The communication apparatus may be a network device, an apparatus (for example, a chip, a chip system, or a circuit) in the network device, or an apparatus that can be used together with the network device.

In a possible implementation, the communication apparatus may include modules or units that one to one correspond to the methods/operations/steps/actions described in the second aspect. The modules or units may be hardware circuits, software, or may be implemented by a hardware circuit in combination with software.

In a possible implementation, the communication apparatus may include: a processing unit, configured to determine first configuration information of a first cell of the communication apparatus, where the first configuration information includes first identification update information and information about a first update moment of the first cell, and the first identification update information is used to determine first identification information used by the first cell at the first update moment or after the first update moment; and a transceiver unit, configured to send the first configuration information.

In a possible implementation, the first identification information includes a physical cell identifier.

In a possible implementation, the first identification information further includes at least one of a frequency and a polarization direction.

In a possible implementation, the first identification update information includes the first identification information.

In a possible implementation, the first identification update information includes a difference between the first identification information and identification information that is used by the first cell before the first update moment.

In a possible implementation, the information about the first update moment includes timer information corresponding to the first update moment or standard time corresponding to the first update moment.

In a possible implementation, the first configuration information further includes third identification update information and information about a third update moment of the first cell. The third identification update information is used to determine third identification information used by the first cell at the third update moment or after the third update moment.

In a possible implementation, the transceiver unit is configured to send the first configuration information to a first communication apparatus in a coverage range of the first cell. Alternatively, the transceiver unit is configured to send the first configuration information to a third communication apparatus corresponding to a second cell, where the second cell is a neighboring cell of the first cell.

In a possible implementation, the transceiver unit is further configured to receive second configuration information sent by the third communication apparatus corresponding to the second cell, where the second configuration information includes second identification update information and information about a second update moment of the second cell, and the second identification update information is used to determine second identification information used by the second cell at the second update moment or after the second update moment. The transceiver unit is further configured to send the second configuration information to the first communication apparatus.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second cell is a first-order neighboring cell of the first cell; or the second cell is a second-order neighboring cell of the first cell.

According to a seventh aspect, a communication apparatus is provided. The communication apparatus may be used in the first communication apparatus in the third aspect. The communication apparatus may be a terminal device, an apparatus (for example, a chip, a chip system, or a circuit) in the terminal device, or an apparatus that can be used together with the terminal device.

In a possible implementation, the communication apparatus may include modules or units that one to one correspond to the methods/operations/steps/actions described in the third aspect. The modules or units may be hardware circuits, software, or may be implemented by a hardware circuit in combination with software.

In a possible implementation, the communication apparatus may include: a receiving unit, configured to receive second configuration information, where the second configuration information includes second identification update information and information about a second update moment of a second cell, the second identification update information is used to determine second identification information used by the second cell at the second update moment or after the second update moment, the second cell is a neighboring cell of a first cell, and the communication apparatus is in a coverage range of the first cell; a processing unit, configured to communicate with the first communication apparatus of the second cell based on the second configuration information by using the second identification information at the second update moment or after the second update moment.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second configuration information further includes fourth identification update information and information about a fourth update moment of the second cell. The fourth identification update information is used to determine fourth identification information used by the second cell at the fourth update moment or after the fourth update moment.

According to an eighth aspect, a communication apparatus is provided. The communication apparatus may be used in the second communication apparatus in the fourth aspect. The communication apparatus may be a network device, an apparatus (for example, a chip, a chip system, or a circuit) in the network device, or an apparatus that can be used together with the network device.

In a possible implementation, the communication apparatus may include modules or units that one to one correspond to the methods/operations/steps/actions described in the fourth aspect. The modules or units may be hardware circuits, software, or may be implemented by a hardware circuit in combination with software.

In a possible implementation, the communication apparatus may include: a transceiver unit, configured to obtain second configuration information, where the second configuration information includes second identification update information and information about a second update moment of a second cell, and the second identification update information is used to determine second identification information used by the second cell at the second update moment or after the second update moment; and the transceiver unit, further configured to send the second configuration information to a first communication apparatus, where the communication apparatus corresponds to a first cell, and the first communication apparatus is in a coverage range of the first cell.

In a possible implementation, the transceiver unit is further configured to receive the second configuration information sent by a third communication apparatus corresponding to the second cell.

In a possible implementation, the second identification information includes a physical cell identifier.

In a possible implementation, the second identification information further includes at least one of a frequency and a polarization direction.

In a possible implementation, the second identification update information includes the second identification information.

In a possible implementation, the second identification update information includes a difference between the second identification information and identification information that is used by the second cell before the second update moment.

In a possible implementation, the information about the second update moment includes timer information corresponding to the second update moment or standard time corresponding to the second update moment.

In a possible implementation, the second configuration information further includes fourth identification update information and information about a fourth update moment of the second cell. The fourth identification update information is used to determine fourth identification information used by the second cell at the fourth update moment or after the fourth update moment.

According to a ninth aspect, an embodiment of this application further provides a first communication apparatus, including a processor, configured to implement the method in the first aspect and the possible implementations.

In a possible implementation, the processor implements the foregoing methods by using a logic circuit.

In another possible implementation, the processor implements the foregoing methods by executing instructions.

Specifically, the processor is configured to: receive first configuration information, where the first configuration information includes first identification update information and information about a first update moment of a first cell of a second communication apparatus, and the first identification update information is used to determine first identification information used by the first cell at the first update moment or after the first update moment; and communicate based on the first configuration information by using the first identification information at the first update moment or after the first update moment, where the first communication apparatus is in a coverage range of the first cell.

According to a tenth aspect, an embodiment of this application further provides a first communication apparatus, including a processor, configured to implement the method in the third aspect and the possible implementations.

In a possible implementation, the processor implements the foregoing methods by using a logic circuit. In another possible implementation, the processor implements the foregoing method by executing instructions.

Specifically, the processor is configured to: receive second configuration information, where the second configuration information includes second identification update information and information about a second update moment of a second cell, the second identification update information is used to determine second identification information used by the second cell at the second update moment or after the second update moment, and the second cell is the neighboring cell of the first cell; and communicate with the first communication apparatus of the second cell based on the second configuration information by using the second identification information at the second update moment or after the second update moment, where the first communication apparatus is in a coverage range of a first cell.

According to an eleventh aspect, an embodiment of this application further provides a second communication apparatus, including a processor, configured to implement the method in the second aspect and the possible implementations.

In a possible implementation, the processor implements the foregoing methods by using a logic circuit.

In another possible implementation, the processor implements the foregoing methods by executing instructions.

Specifically, the processor is configured to: determine first configuration information of a first cell of the communication apparatus, where the first configuration information includes first identification update information and information about a first update moment of the first cell, and the first identification update information is used to determine first identification information used by the first cell at the first update moment or after the first update moment; and send the first configuration information.

According to a twelfth aspect, an embodiment of this application further provides a second communication apparatus, including a processor, configured to implement the method in the fourth aspect and the possible implementations.

In a possible implementation, the processor implements the foregoing methods by using a logic circuit.

In another possible implementation, the processor implements the foregoing methods by executing instructions.

Specifically, the processor is configured to: obtain second configuration information, where the second configuration information includes second identification update information and information about a second update moment of a second cell, and the second identification update information is used to determine second identification information used by the second cell at the second update moment or after the second update moment; send the second configuration information to a first communication apparatus, where the second communication apparatus corresponds to a first cell, and the first communication apparatus is in a coverage range of the first cell.

According to a thirteenth aspect, a communication apparatus is provided, and includes a communication interface and a processor. The communication interface is configured to receive/send data and/or signaling, and the processor is configured to execute a computer program or instructions, to enable the communication apparatus to perform the method according to any one of the first aspect and the possible implementations of the first aspect, according to any one of the second aspect and the possible implementations of the second aspect, according to any one of the third aspect and the possible implementations of the third aspect, or according to any one of the fourth aspect and the possible implementations of the fourth aspect.

In a possible implementation, the communication apparatus further includes a memory. The memory is configured to store the computer program or the instructions.

In a possible implementation, the memory is located outside the communication apparatus.

In a possible implementation, the memory is located inside the communication apparatus.

In a possible implementation, the memory is integrated with the processor.

According to a fourteenth aspect, a communication apparatus is provided, and includes a processor. The processor is coupled to a memory. The processor is configured to execute a computer program or instructions, to enable the communication apparatus to perform the method according to any one of the first aspect and the possible implementations of the first aspect, according to any one of the second aspect and the possible implementations of the second aspect, according to any one of the third aspect and the possible implementations of the third aspect, or according to any one of the fourth aspect and the possible implementations of the fourth aspect.

In a possible implementation, the communication apparatus further includes the memory. The memory is configured to store the computer program or the instructions.

In a possible implementation, the memory is located outside the communication apparatus.

In a possible implementation, the memory is located inside the communication apparatus.

In a possible implementation, the memory is integrated with the processor.

According to a fifteenth aspect, a communication apparatus is provided, and includes a logic circuit and an input/output interface. The logic circuit is configured to execute a computer program or instructions, to enable the communication apparatus to perform the method according to any one of the first aspect and the possible implementations of the first aspect, according to any one of the second aspect and the possible implementations of the second aspect, according to any one of the third aspect and the possible implementations of the third aspect, or according to any one of the fourth aspect and the possible implementations of the fourth aspect.

According to a sixteenth aspect, a computer-readable storage medium is provided, and includes a computer program or instructions. When the computer program or the instructions are run on a computer, the computer is enabled to perform the method according to any one of the first aspect and the possible implementations of the first aspect, according to any one of the second aspect and the possible implementations of the second aspect, according to any one of the third aspect and the possible implementations of the third aspect, or according to any one of the fourth aspect and the possible implementations of the fourth aspect.

According to a seventeenth aspect, a computer program product is provided, and includes instructions. When the instructions are run on a computer, the computer is enabled to perform the method according to any one of the first aspect and the possible implementations of the first aspect, according to any one of the second aspect and the possible implementations of the second aspect, according to any one of the third aspect and the possible implementations of the third aspect, or according to any one of the fourth aspect and the possible implementations of the fourth aspect.

According to an eighteenth aspect, an embodiment of this application further provides a computer program including computer-executable instructions. When the computer program is run, some or all of steps of the method according to any one of the first aspect and the possible implementation of the first aspect, according to any one of the second aspect and the possible implementations of the second aspect, according to any one of the third aspect and the possible implementations of the third aspect, or according to any one of the fourth aspect and the possible implementations of the fourth aspect.

According to a nineteenth aspect, an embodiment of this application further provides a communication system, including the first communication apparatus according to the fifth aspect and the possible implementations of the fifth aspect and according to the seventh aspect and the possible implementations of the seventh aspect, the second communication apparatus according to the sixth aspect and the possible implementations of the sixth aspect and according to the eighth aspect and the possible implementations of the eighth aspect, the terminal according to the ninth aspect and the possible implementations of the ninth aspect and according to the tenth aspect and the possible implementations of the tenth aspect, and the network device according to the eleventh aspect and the possible implementations of the eleventh aspect and according to the twelfth aspect and the possible implementations of the twelfth aspect.

### BRIEF DESCRIPTION OF DRAWINGS

FIG. 1 is a diagram of a satellite communication system according to an embodiment of this application;

FIG. 2 is a diagram of a PCI conflict between first-order neighboring cells/second-order neighboring cells according to an embodiment of this application;

FIG. 3 is an interaction diagram of a communication method according to an embodiment of this application;

FIG. 4 is an interaction diagram of a communication method according to an embodiment of this application;

FIG. 5 is a diagram of avoiding a PCI conflict between first-order neighboring cells according to an embodiment of this application;

FIG. 6 is an interaction diagram of another communication method according to an embodiment of this application;

FIG. 7 is another diagram of avoiding a PCI conflict between first-order neighboring cells according to an embodiment of this application;

FIG. 8 is an interaction diagram of still another communication method according to an embodiment of this application;

FIG. 9 is an interaction diagram of yet another communication method according to an embodiment of this application;

FIG. 10 is a diagram of a communication apparatus according to an embodiment of this application;

FIG. 11 is a diagram of another communication apparatus according to an embodiment of this application;

FIG. 12 is a diagram of still another communication apparatus according to an embodiment of this application; and

FIG. 13 is a diagram of yet another communication apparatus according to an embodiment of this application.

### DESCRIPTION OF EMBODIMENTS

The following describes technical solutions in embodiments of this application with reference to accompanying drawings.

The technical solutions in embodiments of this application may be applied to a non-terrestrial network (non-terrestrial network, NTN) system such as an uncrewed aerial vehicle, a satellite communication system, and high altitude platform station (high altitude platform station, HAPS) communication. The satellite communication system is used as an example. The satellite communication system may be integrated into an existing mobile communication system, for example, a 4th generation (4th generation, 4G) communication system such as a long term evolution (long term evolution, LTE) system, a 5th generation (5th generation, 5G) communication system such as a new radio (new radio, NR) system, and a communication system evolved after 5G such as a 6th generation (6th generation, 6G).

A terminal in embodiments of this application may be a device having a wireless receiving/sending function, and may be specifically user equipment (user equipment, UE), an access terminal, a subscriber unit (subscriber unit), a subscriber station, a mobile station (mobile station), a remote station, a remote terminal, a mobile device, a user terminal, a wireless communication device, a user agent, or a user apparatus. Alternatively, the terminal device may be a satellite phone, a cellular phone, a smartphone, a wireless data card, a wireless modem, a machine type communication device, a cordless phone, a session initiation protocol (session initiation protocol, SIP) phone, a wireless local loop (wireless local loop, WLL) station, personal digital processing (personal digital assistant, PDA), a handheld device with a wireless communication function, a computing device, another processing device connected to a wireless modem, a vehicle-mounted device, a communication device carried on a high-altitude aircraft, a wearable device, an uncrewed aerial vehicle, a robot, a terminal in device-to-device (device-to-device, D2D) communication, a terminal in vehicle to everything (vehicle to everything, V2X), a virtual reality (virtual reality, VR) terminal device, an augmented reality (augmented reality, AR) terminal device, a wireless terminal in industrial control (industrial control), a wireless terminal in self-driving (self-driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a terminal device in a communication network evolved after 5G, or the like. This is not limited in this application.

In embodiments of this application, an apparatus configured to implement a function of the terminal device may be a terminal device, or may be an apparatus, for example, a chip system, that can support the terminal device in implementing the function. The apparatus may be mounted in the terminal device or used together with the terminal device. In embodiments of this application, the chip system may include a chip, or may include a chip and another discrete component.

In embodiments of this application, a network device is a device having a wireless receiving/sending function, and is configured to communicate with the terminal device. An access network device may be a node in a radio access network (radio access network, RAN), may be referred to as a base station, or may be referred to as a RAN node. The access network device may be an evolved base station (evolved NodeB, eNB, or eNodeB) in LTE, a base station in a 5G network such as a gNodeB (gNB), a base station in a public land mobile network (public land mobile network, PLMN) evolved after 5G, a broadband network gateway (broadband network gateway, BNG), an aggregation switch, a non-3rd generation partnership project (3rd generation partnership project, 3GPP) access device, or the like. Optionally, in embodiments of this application, the network device may include various forms of base stations, for example, a macro base station, a micro base station (also referred to as a small cell), a relay station, an access node in a Wi-Fi system, a transmission point (transmitting and receiving point, TRP), a transmitting point (transmitting point, TP), a mobile switching center, and a device that functions as a base station function in device-to-device (Device-to-Device, D2D), vehicle-to-everything (vehicle-to-everything, V2X), or machine-to-machine (machine, M2M) communication. The network device may further include a central unit (central unit, CU) and a distributed unit (distributed unit, DU) in a cloud access network (cloud radio access network, C-RAN) system, or a network device in an NTN communication system. This is not specifically limited in embodiments of this application.

In embodiments of this application, an apparatus configured to implement a function of the network device may be a network device, or may be an apparatus, for example, a chip system, that can support the network device in implementing the function. The apparatus may be mounted in the network device or used together with the network device. In embodiments of this application, the chip system may include a chip, or may include a chip and another discrete component.

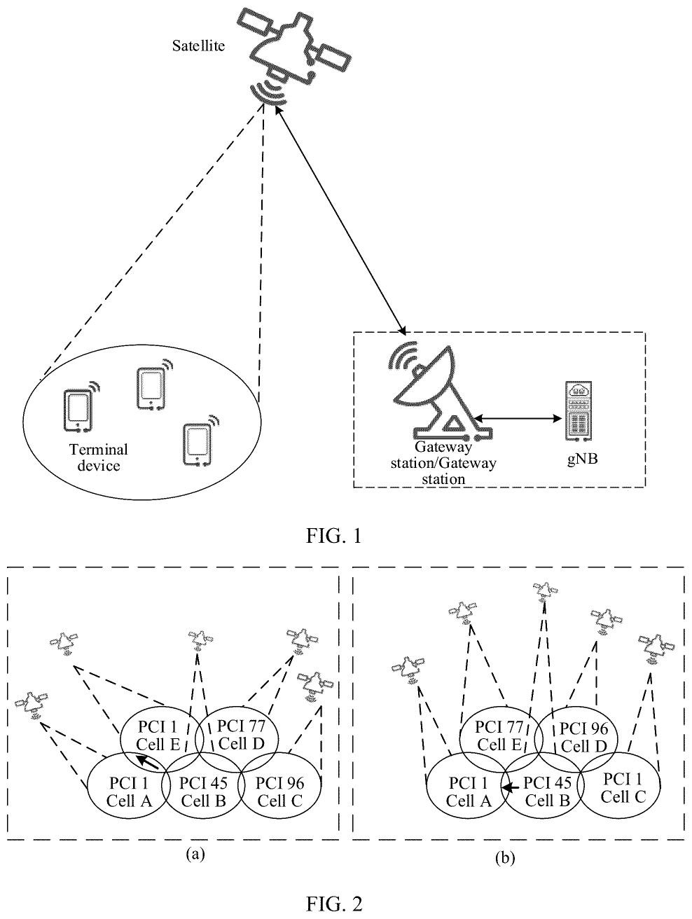

FIG. 1 is a diagram of a satellite communication system according to an embodiment of this application. A satellite device, a gNB, and a gateway station/gateway (gateway) station in the satellite communication system may be considered as network devices. The network device may alternatively be any one listed above. A terminal device may be a device such as a phone or an internet of things (internet of things, IoT) device, or may be any one listed above. A link between the satellite device and the terminal device is referred to as a service link (service link), and a link between the satellite device and the gateway station is referred to as a feeder link (feeder link).

Working modes of the satellite device may be classified into a transparent (transparent) transmission mode and a regeneration (regeneration) mode. When the satellite device works in the transparent transmission mode, the satellite device has a relay forwarding function. If the gateway station has functions of a base station or some functions of the base station, the gateway station may be considered as the base station. Alternatively, the base station and the gateway station may be separately deployed. In this case, latency of the feeder link includes two parts: latency from the satellite to the gateway station and latency from the gateway station to the gNB. When the satellite device works in the regeneration mode, the satellite device has a data processing capability and has functions of a base station or some functions of the base station, and therefore the satellite device may be considered as the base station.

It should be understood that the technical solutions disclosed in embodiments of this application may be further applied to a multi-satellite device communication scenario. Content shown in FIG. 1 is merely used as an example for understanding.

For ease of understanding the technical solutions disclosed in embodiments of this application, the following briefly describes related technical terms in embodiments of this application.

### First: PCI

The PCI is used to distinguish between radio signals of different cells, to ensure that there is no same physical cell identifier in a coverage range of a related cell. The PCI includes a cell identifier 1 N_{ID}¹ and a cell identifier 2 N_{ID}². A calculation relationship is as follows:

$${N}_{ID}^{cell} = 3 {N}_{ID}^{1} + {N}_{ID}^{2} . \qquad ( 1 )$$

N_{ID}^{cell} is a value representing the PCI. A terminal determines a value of the cell identifier 2 N_{ID}² based on an m-sequence used by a primary synchronization signal (primary synchronization signal, PSS) in a synchronization signal and physical broadcast channel block (synchronization signal and physical broadcast channel block, SSB). For example, if the m-sequence is three sequences each having a length of 127 bits, the value of the cell identifier 2 N_{ID}² ranges from 0 to 2. The terminal determines a value of the cell identifier 1 N_{ID}¹ based on a gold sequence used by a secondary synchronization signal (secondary synchronization signal, SSS) in the SSB. For example, if each PSS corresponds to 336 SSS sequences each having a length of 127 bits, the value of the cell identifier 1 N_{ID}¹ ranges from 0 to 335. Therefore, the value of N_{ID}^{cell} ranges from 0 to 1007, and PCIs of a maximum of 1008 cells can have non-repeated names.

When a quantity of satellite devices in a satellite communication system is greater than 1008, different cells may have a same PCI in the satellite communication system. As a constellation scale keeps increasing, it is more common that a plurality of neighboring cells have a same PCI. This causes some problems, for example, a handover failure of the terminal to a neighboring cell. For details, refer to content shown in FIG. 2 below.

The neighboring cell is an adjacent cell. The neighboring cell includes a first-order neighboring cell, a second-order neighboring cell, and a multi-order neighboring cell. The first-order neighboring cell is a directly adjacent cell in a neighboring cell relationship. The second-order neighboring cell is a cell separated by one cell in the neighboring cell relationship. The multi-order neighboring cell is a cell separated by more than two (including two) cells in the neighboring cell relationship.

The neighboring cell relationship is a relationship between adjacent cells. The neighboring cell relationship includes a first-order neighboring cell relationship, a second-order neighboring cell relationship, and a multi-order neighboring cell relationship. The first-order neighboring cell relationship is that two cells are directly adjacent to each other. The second-order neighboring cell relationship is that two cells are separated by one cell. The multi-order neighboring cell relationship is that two cells are separated by more than two (including two) cells.

For example, a cell A and a cell B are first-order neighboring cells of each other, and the cell A and a cell D are second-order neighboring cells of each other. In other words, a first-order neighboring cell of the cell A is the cell B, and a second-order neighboring cell of the cell A is the cell D. A first-order neighboring cell of the cell B is the cell A, and a second-order neighboring cell of the cell D is the cell A.

FIG. 2 is a diagram of a PCI conflict between first-order neighboring cells/second-order neighboring cells according to an embodiment of this application. FIG. 2a is a diagram of the PCI conflict between the first-order neighboring cells. FIG. 2b is a diagram of the PCI conflict between the second-order neighboring cells (where the PCI conflict between the second-order neighboring cells may also be understood as PCI confusion between the second-order neighboring cells). A black arrow represents a moving direction of a terminal device. Content shown in FIG. 2 is merely used as an example for understanding, and is not used to limit the protection scope claimed in embodiments of this application.

In FIG. 2a, a cell A and a cell E have a same PCI, and the cell A and the cell E are first-order neighboring cells of each other. When the terminal is handed over from a cell on which the terminal camps, namely, a cell B, to either of the cell A and the cell E, a source gNB corresponding to the cell B cannot distinguish, based on a PCI reported by the terminal, a cell to which the terminal needs to be handed over. As a result, the source gNB may send a handover request to an incorrect target gNB, causing a handover failure.

In FIG. 2b, a cell A and a cell C have a same PCI, and the cell A and the cell C are second-order neighboring cells of each other. The cell A and the cell C are both adjacent to a cell B cell. The terminal camps on the cell B cell. When the terminal moves to the cell A and reports a measurement result (where the measurement result includes that a PCI of a cell is 1) to a source gNB corresponding to the cell B, the source gNB corresponding to the cell B cannot distinguish, based on the PCI reported by the terminal, a cell that the terminal measures. As a result, the source gNB cannot complete handover or the source gNB sends a handover request to an incorrect adjacent gNB (target gNB).

As shown in FIG. 2, due to the PCI conflict between the first-order neighboring cells/second-order neighboring cells, when the terminal needs be handed over, a network device cannot correctly complete behavior of handing over the terminal from a cell on which the terminal camps to a target neighboring cell. Therefore, a problem of a conflict between a plurality of neighboring cells having a same PCI in a large-scale constellation communication system needs to be avoided. In other words, a problem of cell identifier confusion or a cell identifier conflict between neighboring cells in the large-scale constellation communication system needs to be avoided.

It should be understood that the problem shown in FIG. 2 is merely an example of the conflict between the plurality of neighboring cells having the same PCI, and another example of the conflict between the plurality of neighboring cells having the same PCI is not limited in embodiments of this application.

For ease of description, embodiments of this application are described based on the problem shown in FIG. 2. However, the descriptions cannot exclude the another example of the conflict between the plurality of neighboring cells having the same PCI.

It should be understood that in addition to the conflict between the plurality of neighboring cells having the same PCI, a conflict may also occur between a plurality of adjacent cells having same PCI mod N. For example, a demodulation reference signal (demodulation reference signal, DMRS) and a sounding reference signal (sounding reference signal, SRS) of a physical uplink shared channel (physical uplink shared channel, PUSCH)/physical uplink control channel (physical uplink control channel, PUCCH) are associated with a ZC sequence. The ZC sequence has 30 groups of roots, and the root is associated with the PCI. If adjacent cells have PCIs meeting a mod N relationship (where mod represents modulo) and use a same frequency, interference is also caused between uplink reference signals. Therefore, a case in which the adjacent cells have same PCI mod N needs to be avoided. N is a positive integer. For example, N may be equal to 30, or may be another value.

In view of the foregoing technical problem, embodiments of this application provide a communication method and a communication apparatus, to resolve a problem of a conflict between a plurality of neighboring cells having a same PCI (or same PCI mod N) in a large-scale constellation communication system, or to resolve a problem of cell identifier confusion or a cell identifier conflict between neighboring cells in the large-scale constellation communication system.

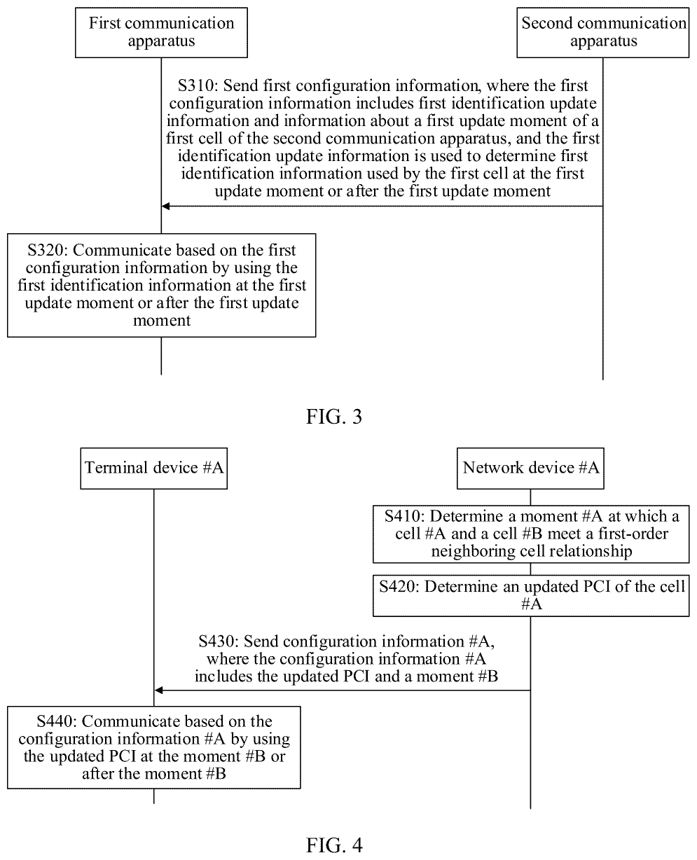

FIG. 3 is a schematic flowchart of a communication method according to an embodiment of this application. The method includes the following steps.

S310: A second communication apparatus sends first configuration information to a first communication apparatus.

Correspondingly, the first communication apparatus receives the first configuration information sent by the second communication apparatus.

The first configuration information includes first identification update information and information about a first update moment of a first cell of the second communication apparatus. The first identification update information is used to determine first identification information used by the first cell at the first update moment or after the first update moment.

In a possible implementation, the first configuration information sent by the second communication apparatus to the first communication apparatus may be determined based on ephemeris information. For example, the second communication apparatus may determine identification information and update time information of each cell of the second communication apparatus based on the ephemeris information, to determine the first configuration information. For another example, a terrestrial network management unit/gateway configures identification information and update time information of each cell of the second communication apparatus based on the ephemeris information, and sends the identification information and the update time information to the second communication apparatus. Then, the second communication apparatus sends the identification information and the update time information of each cell to the first communication apparatus in a coverage range of each cell. More specifically, the terrestrial network management unit/gateway may determine the first configuration information based on information such as satellite constellation distribution and cell distribution, and send the first configuration information to the second communication apparatus. Further, the second communication apparatus sends the first configuration information to the first communication apparatus.

The first communication apparatus may be any one of terminal devices in a coverage range of a cell (where the terminal device referring to the first communication apparatus is used for description below), and the second communication apparatus may be a network device corresponding to the cell (where the network device referring to the second communication apparatus is used for description below). The cell may be the first cell. Therefore, the foregoing content may be understood as follows: A network device corresponding to the first cell sends the first configuration information to a terminal device in a coverage range of the first cell.

The first configuration information includes two parameters of the first cell: the first identification update information and the information about the first update moment. The first identification update information is information used to determine the first identification information used by the first cell at the first update moment or after the first update moment. The information about the first update moment is information indicating a moment at which identification information of the first cell is updated or changed.

For example, before the first update moment, a PCI of a cell #S is the same as a PCI of the first cell, and identification information of the cell #S is also the same as the identification information of the first cell. The cell #S is far away from the first cell, and the cell #S and the first cell do not meet a neighboring cell relationship. This does not cause a problem. With the movement of a satellite device and the change of a coverage area, a distance between the cell #S and the first cell may be shortened, and the cell #S and the first cell meet the neighboring cell relationship, in other words, the cell #S is a neighboring cell of the first cell. When the identification information of the cell #S is the same as the identification information of the first cell, and the cell #S and the first cell meet the neighboring cell relationship, the problem shown in FIG. 2 may occur.

Therefore, before the cell #S becomes the neighboring cell of the first cell, the network device corresponding to the first cell sends the first configuration information to the terminal device in the coverage range of the first cell, so that the terminal device in the coverage range of the first cell learns that the identification information used by the first cell at the first update moment or after the first update moment is changed to the first identification information determined based on the first identification update information. In this way, the identification information of the first cell and the identification information of the cell #S can be distinguished from each other, thereby avoiding cell identifier confusion or a cell identifier conflict between the first cell and the cell #S.

In a possible implementation, the first identification information includes a PCI. For example, the PCI of the first cell is the same as the PCI of the cell #S before the first update moment, and the first cell may use an updated PCI at the first update moment or after the first update moment, so that the PCI of the first cell and the PCI of the cell #S can be distinguished from each other. This can avoid the PCI confusion or the PCI conflict between the first cell and the cell #S.

In a possible implementation, the first identification information includes a frequency. For example, the PCI and a frequency of the first cell are the same as the PCI and a frequency of the cell #S before the first update moment, and the first cell may use an updated frequency at the first update moment or after the first update moment, so that the frequency of the first cell and the frequency of the cell #S can be distinguished from each other, thereby avoiding frequency confusion or a frequency conflict between the first cell and the cell #S.

In a possible implementation, the first identification information includes a polarization direction. For example, the PCI, the frequency, and a polarization direction of the first cell are the same as the PCI, the frequency, and a polarization direction of the cell #S before the first update moment, and the first cell may use an updated polarization direction at the first update moment or after the first update moment, so that the polarization direction of the first cell and the polarization direction of the cell #S can be distinguished from each other, thereby avoiding polarization direction confusion or a polarization direction conflict between the first cell and the cell #S.

For example, if the PCI, the frequency, and the polarization direction of the first cell are the same as the PCI, the frequency, and the polarization direction of the cell #S before the first update moment, at least one of the three parameters: the PCI, the frequency, and the polarization direction of the first cell may be changed, so that the first cell is distinguished from the cell #S. For example, if the PCI of the first cell is the same as the PCI of the cell #S before the first update moment, the PCI of the first cell may be changed, so that the PCI of the first cell is different from the PCI of the cell #S. For example, if the PCI and the polarization direction of the first cell are the same as the PCI and the polarization direction of the cell #S before the first update moment, the polarization direction or the PCI of the first cell may be changed, so that the polarization direction or the PCI of the first cell is different from the polarization direction or the PCI of the cell #S. For another example, if the PCI and the frequency of the first cell are the same as the PCI and the frequency of the cell #S before the first update moment, the frequency or the PCI of the first cell may be changed, so that the first cell is distinguished from the cell #S. If the PCI, the frequency, and the polarization direction of the first cell are the same as the PCI, the frequency, and the polarization direction of the cell #S before the first update moment, at least one of the two parameters: the frequency and the polarization direction of the first cell may be changed, so that the first cell is distinguished from the cell #S.

When the PCI, the frequency, and the polarization direction of the first cell are the same as the PCI, the frequency, and the polarization direction of the cell #S, one of the foregoing three parameters, both two of the foregoing three parameters, or all of the foregoing three parameters may be changed. This is not limited in this embodiment of this application.

When the PCI of the first cell is the same as the PCI of the cell #S, one of the foregoing three parameters, both two of the foregoing three parameters, or all of the foregoing three parameters may be changed. This is not limited in this embodiment of this application.

The first update moment may be a moment at which the cell #S becomes the neighboring cell of the first cell, or may be a moment before the moment at which the cell #S becomes the neighboring cell of the first cell. When the first update moment is the moment at which the cell #S becomes the neighboring cell of the first cell, the first identification update information is used to determine the first identification information used by the first cell at the first update moment or after the first update moment. Alternatively, the first communication apparatus starts to use the first identification information from the first update moment. When the first update moment is the moment before the moment at which the cell #S becomes the neighboring cell of the first cell, the first identification update information may be used to determine the first identification information used by the first cell at the first update moment or after the first update moment. Alternatively, the first communication apparatus starts to use the first identification information from the first update moment or a moment after the first update moment.

The moment after the first update moment may be understood as the moment before the moment at which the cell #S becomes the neighboring cell of the first cell, or may be equal to the moment at which the cell #S becomes the neighboring cell of the first cell.

It should be understood that the first identification information may include the PCI, the frequency, or the polarization direction, may include the frequency and the polarization direction, may include the PCI, the frequency, and the polarization direction, or may include other information. This is not limited in this embodiment of this application.

The first identification update information may be the first identification information, or a difference between the first identification information and identification information that is used by the first cell before the first update moment. The difference may be a positive value or a negative value. This is further described below.

S320: The first communication apparatus communicates based on the first configuration information by using the first identification information at the first update moment or after the first update moment.

Specifically, after receiving the first configuration information, the terminal device in the coverage range of the first cell may perform corresponding communication based on the first configuration information by using the first identification information at the first update moment or after the first update moment. This is further described below.

When the first update moment is the moment at which the cell #S becomes the neighboring cell of the first cell, the terminal device in the coverage range of the first cell may communicate by using the first identification information at the first update moment. When the first update moment is the moment before the moment at which the cell #S becomes the neighboring cell of the first cell, the terminal device in the coverage range of the first cell may communicate by using the first identification information at the first update moment or after the first update moment. The moment after the first update moment may be understood as the moment before the moment at which the cell #S becomes the neighboring cell of the first cell, or may be equal to the moment at which the cell #S becomes the neighboring cell of the first cell.

In a possible implementation, in FIG. 2, the measurement result reported by the terminal to the network device may include at least one of a PCI, a frequency, and a polarization direction of a cell. In this case, the network device may determine, based on the measurement result, a target cell (target cell) to which the terminal is to be handed over, and trigger the terminal to be handed over from the cell on which the terminal device camps to the target cell.

Specifically, the source gNB determines, according to a handover principle, the target cell to which the terminal is to be handed over. For example, a cell with a strongest signal may be selected as the target cell for handover. Because cells are different in at least one of a PCI, a frequency, or a polarization direction, the source gNB distinguishes a specific target cell based on the at least one of the PCI, the frequency, or the polarization direction, so that a conflict problem does not occur.

In addition, identification information that is of the target cell and that is sent by the source gNB to the terminal may include the PCI, may include the PCI and the frequency, may include the PCI and the polarization direction, or may include the PCI, the frequency, and the polarization direction. In this way, a case in which the terminal confuses adjacent cells having a same PCI can be avoided.

It should be understood that in this embodiment of this application, an SSB of the first cell and an SSB of the neighboring cell of the first cell may use a same frequency, and the terminal device in the coverage range of the first cell and a terminal device in a coverage range of the neighboring cell of the first cell may also perform intra-frequency measurement for neighboring cell measurement. Unified descriptions are provided herein. Details are not described below.

The identification information of the first cell is updated at or before a moment at which a cell that has a same identifier as the first cell becomes the neighboring cell of the first cell, so that the network device can distinguish between the first cell and the neighboring cell based on identification information of different cells, to avoid a cell identifier conflict or cell identifier confusion between the first cell and the neighboring cell, and avoid a problem such as a cell handover failure caused by the cell identifier conflict or the cell identifier confusion. According to the foregoing technical solution, in this embodiment of this application, a problem of a cell handover failure caused by a cell identifier conflict or cell identifier confusion between neighboring cells having same PCI mod N can also be avoided.

The following describes, with reference to FIG. 4 to FIG. 9, other communication methods provided in embodiments of this application.

For ease of description, in the following embodiments of this application, an example in which a neighboring cell relationship is a first-order neighboring cell relationship is used for description, and the neighboring cell relationship may also be extended to a second-order neighboring cell relationship and a multi-order neighboring cell relationship. In addition, technical solutions corresponding to the second-order neighboring cell relationship and the multi-order neighboring cell relationship are similar to technical solutions corresponding to the first-order neighboring cell relationship. Therefore, for the technical solutions corresponding to the second-order neighboring cell relationship and the multi-order neighboring cell relationship, refer to the technical solutions corresponding to the first-order neighboring cell relationship. Therefore, details are not described again.

FIG. 4 is a schematic flowchart of a communication method according to an embodiment of this application. The method includes the following steps.

S410: A network device #A determines a moment #A at which a cell #A and a cell #B meet a first-order neighboring cell relationship.

The cell #A and the cell #B are two cells having a same PCI. For example, the PCI of the cell #A is #100, and the PCI of the cell #B is also #100.

It should be understood that the cell #A and the cell #B may alternatively be two cells having same PCI mod N. N may be equal to 30. When the cell #A and the cell #B are first-order neighboring cells having same PCI mod 30, the network device #A also needs to change identification information of the cell #A, to avoid a conflict between the cell #A and the cell #B. The descriptions are also applicable to the following descriptions. Details are not described below again.

As a satellite device moves, a distance between the cell #A and the cell #B may be shortened, and the cell #A and the cell #B may meet the first-order neighboring cell relationship (refer to FIG. 2a). That the cell #A and the cell #B have the same PCI may cause the problem shown in FIG. 2.

It should be understood that the network device #A may predict a time-varying characteristic of a neighboring cell relationship in an NTN based on ephemeris information of the satellite device, and determine, based on the time-varying characteristic, the moment #A at which the cell #A and the cell #B meet the first-order neighboring cell relationship. The cell #A is one of cells corresponding to the network device #A. The cell #B may be one of the cells corresponding to the network device #A, or may not be one of the cells corresponding to the network device #A.

S420: The network device #A determines an updated PCI of the cell #A.

To avoid a problem that when the cell #A and the cell #B meet the first-order neighboring cell relationship, a PCI conflict between first-order neighboring cells occurs because the cells have the same PCI, the network device #A needs to update the PCI of the cell #A, in other words, determine the updated PCI of the cell #A. The updated PCI can enable the cell #A and the cell #B to be distinguished from each other based on the PCIs. The updated PCI is different from a PCI of a neighboring cell of the cell #A. For example, the network device #A may determine the updated PCI of the cell #A based on information exchange with a network device corresponding to the neighboring cell of the cell #A.

In a possible example, in S420 #A, the network device #A determines a PCI difference between the updated PCI and the PCI that is not updated of the cell #A. The PCI difference may be a positive value or a negative value. This is described below.

S430: The network device #A sends configuration information #A to a terminal device #A, where the configuration information #A includes the updated PCI and a moment #B.

Correspondingly, the terminal device #A receives the configuration information #A sent by the network device #A. The terminal device #A is located in a coverage range of the cell #A.

In a possible implementation, the configuration information #A sent by the network device #A to the terminal device #A may be determined based on the ephemeris information.

For example, the network device #A may determine identification information and update time information of each cell of the network device #A based on the ephemeris information, to determine the configuration information #A.

For another example, a terrestrial network management unit/gateway configures identification information and update time information of each cell of the network device #A based on the ephemeris information, and sends the identification information and the update time information to the network device #A. Then, the network device #A sends the identification information and the update time information of each cell to a terminal device in a coverage range of each cell. More specifically, the terrestrial network management unit/gateway may determine the configuration information #A based on information such as satellite constellation distribution and cell distribution, and send the configuration information #A to the network device #A. Further, the network device #A sends the configuration information #A to the terminal device #A. In other words, the network device #A may determine the configuration information #A based on the identification information and the update time information of each cell of the network device #A that are determined by the terrestrial network management unit/gateway based on the ephemeris information and that are sent by the terrestrial network management unit/gateway to the network device #A. Alternatively, the terrestrial network management unit/gateway determines the configuration information #A based on the information such as the satellite constellation distribution and the cell distribution, and sends the configuration information #A to the network device #A. The network device #A sends a PCI and time information of a first cell (and a neighboring cell of the first cell) to a terminal device in a coverage range of a corresponding cell. The descriptions are also applicable to the following descriptions of a frequency and a polarization direction. Details are not described below again.

In a possible implementation, the configuration information #A may be a PCI update information element (PCI update information element). The PCI update information element includes the updated PCI and the moment #B.

It should be understood that the moment #B may be the moment #A or a moment before the moment #A. The moment #B represents a moment at which the PCI of the cell #A is changed. The PCI of the cell #A may be changed at the moment #A or earlier than the moment #A.

For example, a structure of the PCI update information element is shown in Table 1.

TABLE 1
PCI update information element

| PCI_update: | |
|---|---|
| PCI_value | Integer (integer) |
| TimeInfo_UTC | Integer (integer) |

Alternatively, a structure of the PCI update information element may be shown as follows:

-- ASN1START
-- TAG-BWP-START
PCI_update = SEQUENCE {
PCI_value INTEGER (0..1007),
TimeInfo_UTC INTEGER (0..549755813887)
}
-- TAG-BWP-STOP
-- ASN1STOP

PCI_value represents the updated PCI, for example, may be represented by using 10 bits. TimeInfo_UTC represents the moment #B, and is a coordinated universal time (coordinated universal time, UTC) time parameter, for example, may be represented by using 39 bits. A time unit of TimeInfo_UTC may be 10 ms, and starts from a date in a Gregorian calendar (Gregorian calendar): Jan. 1, 1900 (24:00 on Dec. 31, 1899 or 00:00 on Jan. 1, 1900).

In a possible implementation, the moment #B corresponds to a timer (timer). For example, if the network device #A configures a timer whose length is 10 seconds for the terminal device #A, the terminal device #A starts the timer after receiving the configuration information #A, and may use the updated PCI after the timer expires (that is, after 10 seconds). The timer is used, so that in this embodiment of this application, a moment at which the identification information of the cell is updated or changed can be accurately indicated.

In a possible implementation, the moment #B may alternatively correspond to Greenwich mean time (Greenwich mean time, GMT). The UTC time or the GMT time is used, so that in this embodiment of this application, the moment at which the identification information of the cell is updated or changed can be more accurately indicated.

It should be understood that the UTC and the GMT may be referred to as standard time. The standard time may further include another type of time. The moment #B may correspond to the standard time, or may correspond to the timer.

In another possible example, in S430 #A, configuration information #A sent by the network device #A to a terminal device #A includes a PCI difference and a moment #B. The PCI difference is determined by the network device #A based on the updated PCI and the PCI that is not updated of the cell #A. The PCI difference may be positive or negative. For example, if the updated PCI of the cell #A is 100, and the PCI that is not updated is 90, the PCI difference is (+10). The updated PCI obtained by the terminal device based on 90+10 is 100. For another example, if the updated PCI of the cell #A is 90, and the PCI that is not updated is 100, the PCI difference is (−10). The updated PCI obtained by the terminal device based on 100−10 is 90. The network device #A sends the PCI difference to the terminal device #A, and the terminal device #A determines the updated PCI of the cell #A based on the PCI difference.

It should be understood that first identification update information includes the updated PCI, so that the terminal device can directly obtain an updated PCI of the first cell. A PCI difference between the updated PCI and a PCI that is used by the first cell before a first update moment is indicated, so that signaling overheads can be reduced.

In a possible implementation, the network device #A may send the configuration information #A to the terminal device #A in the coverage range of the cell #A in a broadcast/multicast manner. In this way, a case in which different resources are scheduled for different terminal devices for a purpose of sending the foregoing configuration information can be avoided, thereby reducing signaling overheads of scheduled resources and reducing system scheduling complexity.

S440: The terminal device #A communicates based on the configuration information #A by using the updated PCI at the moment #B or after the moment #B.

Alternatively, the terminal device #A starts to use the updated PCI at the moment #B or after the moment #B to communicate.

A moment after the moment #B may be earlier than the moment #A or equal to the moment #A. To be specific, the PCI of the cell #A needs to be updated or changed at the moment #A or before the moment #A. The descriptions are also applicable to subsequent content of embodiments of this application, and are not emphasized below.

Specifically, the terminal device #A measures a cell of the network device #A by using the updated PCI, and communicates with the network device #A. The network device #A also communicates with the terminal device #A by using the updated PCI, and communicates with the terminal device #A by using a system sequence corresponding to the updated PCI. The system sequence includes a corresponding pilot (a PSS, an SSS, a channel state information reference signal (channel state information reference signal, CSI-RS), a demodulation reference signal (demodulation reference signal, DMRS), a sounding reference signal (sounding reference signal, SRS), and the like), a scrambling code, and the like. The foregoing pilot sequence, the scrambling code, and the like may be generated based on a PCI of a cell.

In a possible implementation, if the configuration information #A includes the PCI difference, the terminal device #A determines the updated PCI of the cell #A based on the PCI difference and the PCI that is not updated.

The PCI shown in FIG. 4 may be understood as the first identification information shown in FIG. 3. The updated PCI or the PCI difference shown in FIG. 4 may be understood as the first identification update information shown in FIG. 3. The moment #B shown in FIG. 4 may be understood as the first update moment shown in FIG. 3. The UTC, the GMT, and the timer shown in FIG. 4 may be understood as the information about the first update moment shown in FIG. 3.

In the technical solution shown in FIG. 3, the network device #A may determine, based on prediction, a PCI corresponding to another moment of the cell #A. In this way, a plurality of PCIs in a period of time can be determined by using one piece of configuration information. In this way, frequently sending the configuration information for a plurality of times can be avoided, and signaling resources can be saved. For example, PCIs corresponding to a plurality of periods of time of the cell #A are shown in Table 2a. PCIs corresponding to a plurality of moments of the cell #A are shown in Table 2b.

TABLE 2a
PCIs corresponding to the plurality
of periods of time of the cell #A

| Period of time | PCI |
|---|---|
| Before the moment #A | 100 |
| Moment #A to moment #F | 90 |
| Moment #F to moment #Z | 120 |

TABLE 2b
PCIs corresponding to the plurality
of moments of the cell #A

| Moment | PCI |
|---|---|
| Moment #A | 90 |
| Moment #F | 120 |
| Moment #Z | 130 |

In Table 2a, the cell #A and the cell #B have a same PCI (which is 100) before the moment #A, and the cell #B becomes a first-order neighboring cell of the cell #A at the moment #A. The PCI of the cell #A needs to be changed or updated from 100 to 90 at the moment #A or before the moment #A. The cell #A and a cell #D have a same PCI (which is 90) before the moment #F, and the cell #D becomes a first-order neighboring cell of the cell #A at the moment #F. The PCI of the cell #A needs to be changed or updated from 90 to 120 at the moment #F or before the moment #F. The cell #A and a cell #G have a same PCI (which is 120) before the moment #Z, and the cell #G becomes a first-order neighboring cell of the cell #A at the moment #Z. The PCI of the cell #A needs to be changed or updated from 120 to 130 at the moment #Z or before the moment #Z.

In Table 2b, the PCI of the cell #A at the moment #A is 90, the PCI of the cell #A at the moment #F is 120, and the PCI of the cell #A at the moment #Z is 130. PCIs corresponding to different moments are indicated, so that in this embodiment of this application, the PCI of the first cell and the PCI of the neighboring cell can be distinguished from each other. This can avoid a conflict between a plurality of neighboring cells having a same cell identifier, and avoid a cell handover failure caused by a cell identifier conflict or cell identifier confusion.

Table 2a and Table 2b are two example expressions, and another expression is not limited in this embodiment of this application.

It should be understood that the configuration information #A may include one updated PCI and one update moment (refer to Table 1), or may include a plurality of updated PCIs and a plurality of update moments (refer to Table 2).

The network device #A may send content shown in Table 2 as the configuration information #A to the terminal device #A in the coverage range of the cell #A, and the terminal device #A changes or updates the PCI based on time information shown in Table 2.

In an embodiment, the configuration information #A sent by the network device #A to the terminal device #A may be configuration information that is sent by the network device corresponding to the neighboring cell of the cell #A and that is received by the network device #A. This is further described below.

In another embodiment, the network device #A may send the configuration information #A to the network device corresponding to the neighboring cell of the cell #A. In this way, a terminal device in a coverage range of the neighboring cell of the first cell can measure the first cell by using updated identification information and communicate with a network device corresponding to the first cell. This is further described below.

It should be understood that step S410 and step S420 may be simultaneously performed, or may be sequentially performed. This is not specifically limited in this embodiment of this application.

The PCI of the first cell is changed at or before a moment at which a cell that has a same PCI (or same PCI mod N) as the first cell becomes the neighboring cell of the first cell, so that in this embodiment of this application, the first cell and a cell that has a same PCI that is not updated as the first cell can be distinguished from each other based on different PCIs of the cells. In this way, PCI confusion or a PCI conflict between the first cell and the neighboring cell can be avoided.

It should be understood that in the technical solution shown in FIG. 4, a frequency and/or a polarization direction of the cell #A may be the same as or different from a frequency and/or a polarization direction of the cell #B. This is not limited in this embodiment of this application.

It should be understood that the network device #A may be understood as the foregoing second communication apparatus, and the terminal device #A may be understood as the foregoing first communication apparatus.

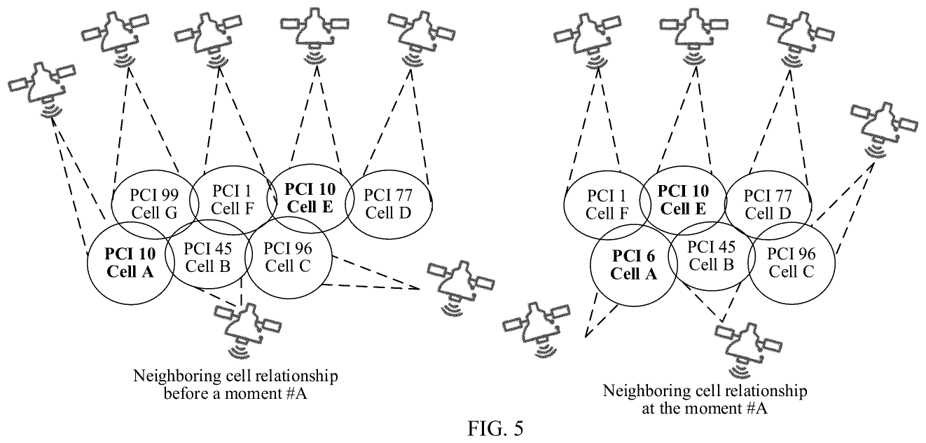

FIG. 5 is an example description of the technical solution shown in FIG. 4.

FIG. 5 is a diagram of avoiding a PCI conflict between first-order neighboring cells according to an embodiment of this application. In FIG. 5, the cell #A is a cell A, and the cell #B is a cell E. A PCI of the cell A and a PCI of the cell E are both 10. Before the moment #A, the cell A and the cell E do not meet the first-order neighboring cell relationship. At the moment #A, the cell A and the cell E meet the first-order neighboring cell relationship. A network device corresponding to the cell A needs to update the PCI at the moment #A or before the moment #A, and an updated PCI is different from either a PCI of a cell B or a PCI of a cell F. For example, a value of the PCI of the cell A is changed from 10 to 6. At the moment #A, the cell A and the cell E meet the first-order neighboring cell relationship, but the PCI of the cell A and the PCI of the cell E are different. This avoids the PCI conflict between the first-order neighboring cells.

The technical solution shown in FIG. 4 is also applicable to a scenario in which the cell #A and the cell #B meet a second-order neighboring cell relationship or a multi-order neighboring cell relationship. Specific content is consistent with the foregoing content. Details are not described herein again.

The configuration information #A shown in FIG. 4 may be included in at least one of the following broadcast information: a system information block (system information block, SIB), other system information (other system information, OSI), a master information block (master information block, MIB), and the like, and is sent by a network device to a terminal device in a broadcast or multicast manner. In this way, a case in which different resources are scheduled for different terminal devices for a purpose of sending the foregoing signaling can be avoided, thereby reducing signaling overheads of scheduled resources and reducing system scheduling complexity.

In a possible implementation, when sending the configuration information #A to the terminal device in a radio resource control (radio resource control, RRC) connection setup phase and a subsequent communication process, the network device may send the configuration information #A by using a unicast/multicast message, for example, include the configuration information #A in at least one of RRC signaling (for example, an RRC setup (RRCsetup) message, RRC reconfiguration signaling (RRCReconfiguration), and RRC resume signaling (RRCResume)), downlink control information (downlink control information, DCI), group DCI, a medium access control (medium access control, MAC) control element (control element, CE), and a timing advance command (timing advance command, TAC), or send the configuration information #A to the terminal device in a unicast or multicast manner along with data transmission or in a separately allocated physical downlink shared channel (physical downlink shared channel, PDSCH) bearer. In this way, a message related to PCI update of a cell on which the terminal device camps/neighboring cell may be timely sent to the terminal device without waiting for update latency of a broadcast message (where the broadcast message is periodically updated). This is more timely.

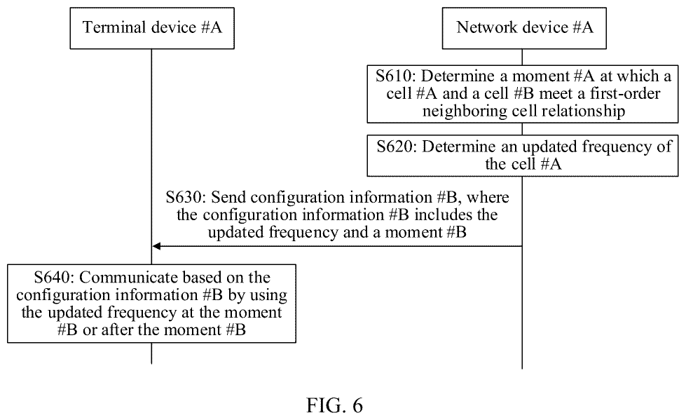

FIG. 6 is a schematic flowchart of another communication method according to an embodiment of this application. The method includes the following steps.

S610: Same as step S410.

S620: A network device #A determines an updated frequency of a cell #A.

To avoid a problem that when the cell #A and a cell #B meet a first-order neighboring cell relationship, a PCI conflict between first-order neighboring cells occurs because the cells have a same PCI, the network device #A may update a frequency of the cell #A, in other words, determine the updated frequency of the cell #A. The updated frequency can enable the cell #A and the cell #B to be distinguished from each other based on frequencies.

It should be understood that the updated frequency of the cell #A may be the same as or different from a frequency of another neighboring cell that has a different PCI and that is of the cell #A.

In a possible example, in S620 #A, the network device #A determines a frequency difference between the updated frequency and the frequency that is not updated of the cell #A. The frequency difference may be a positive value or a negative value. This is described below.

S630: The network device #A sends configuration information #B to a terminal device #A, where the configuration information #B includes the updated frequency and a moment #B.

Correspondingly, the terminal device #A receives the configuration information #B sent by the network device #A. The terminal device #A is located in a coverage range of the cell #A.

In a possible implementation, the configuration information #B may be a frequency update information element (frequency update information element). The frequency update information element includes the updated frequency and the moment #B.

It should be understood that the moment #B may be a moment #A or a moment before the moment #A. The moment #B represents a moment at which the frequency of the cell #A is changed. The moment may be the moment #A or earlier than the moment #A.

For example, a structure of the frequency update information element is shown in Table 3.

TABLE 3
Frequency update information element

| Frequency_update: | |
|---|---|
| Frequency_info | Frequency information (Frequency_info) |
| TimeInfo_UTC | Integer (integer) |

Alternatively, a structure of the frequency update information element may be shown as follows:

-- ASN1START
-- TAG-BWP-START
Frequency _update = SEQUENCE {
Frequency_infoFrequency_info,
TimeInfo_UTC INTEGER (0..549755813887)
}
-- TAG-BWP-STOP
-- ASN1STOP

Frequency_value represents the updated frequency. TimeInfo_UTC represents the moment #B. TimeInfo_UTC may be represented by using 39 bits. For specific descriptions of the moment #B, refer to the foregoing content. Details are not described herein again.

In another possible example, in S630 #A, configuration information #B sent by the network device #A to a terminal device #A includes a frequency difference and a moment #B. The frequency difference is determined by the network device #A based on the updated frequency and the frequency that is not updated of the cell #A. For example, if the updated frequency of the cell #A is 100 GHz, and the frequency that is not updated is 90 GHz, the frequency difference is (+10) GHz, and the updated frequency obtained by the terminal device based on 90 MHz+10 MHz is 100 MHz. For another example, if the updated frequency of the cell #A is 90 GHZ, and the frequency that is not updated is 100 GHz, the frequency difference is (−10) GHz, and the updated frequency obtained by the terminal based on 100 MHz-10 MHz is 90 MHz. The frequency difference is positive or negative. The network device #A may send the frequency difference to the terminal device #A, and then the terminal device #A determines the updated frequency of the cell #A based on the frequency difference. The frequency difference is configured, so that signaling overheads can be reduced.

The updated frequency is directly carried in the configuration information #B, so that in this embodiment of this application, the terminal device can directly obtain an updated frequency of a first cell. The frequency difference is carried in the configuration information #B, so that in this embodiment of this application, the signaling overheads can be reduced.

The network device #A may send the configuration information #B to the terminal device #A in the coverage range of the cell #A in a broadcast/multicast manner. In this way, a case in which different resources are scheduled for different terminal devices for a purpose of sending the foregoing configuration information can be avoided, thereby reducing signaling overheads of scheduled resources and reducing system scheduling complexity.

S640: The terminal device #A communicates based on the configuration information #B by using the updated frequency at the moment #B or after the moment #B.

Alternatively, the terminal device #A starts to use the updated frequency at the moment #B or after the moment #B to communicate.

Specifically, after receiving the configuration information #B, the terminal device #A obtains messages such as a synchronization signal, a MIB, and a SIB from the network device #A by using the updated frequency, and communicates with the network device #A. The network device #A also sends the messages such as the MIB and the SIB by using the updated frequency.

In a possible implementation, if the configuration information #B includes the frequency difference, the terminal device #A needs to determine the updated frequency of the cell #A based on the frequency difference and the frequency that is not updated.

The frequency shown in FIG. 6 may be understood as the first identification information shown in FIG. 3. The updated frequency or the frequency difference shown in FIG. 6 may be understood as the first identification update information shown in FIG. 3. The moment #B shown in FIG. 6 may be understood as the first update moment shown in FIG. 3.

In the technical solution shown in FIG. 6, the network device #A may determine, based on prediction, a frequency corresponding to another moment of the cell #A. In this way, a plurality of frequencies in a period of time can be determined by using one piece of configuration information. In this way, frequently sending the configuration information for a plurality of times can be avoided, and signaling resources can be saved. For example, frequencies corresponding to a plurality of periods of time of the cell #A are shown in Table 4a. Frequencies corresponding to a plurality of moments of the cell #A are shown in Table 4b.

TABLE 4a
Frequencies corresponding to the plurality
of periods of time of the cell #A

| Period of time | Frequency |
|---|---|
| Before the moment #A | Frequency 1 |
| Moment #A to moment #F | Frequency 2 |
| Moment #F to moment #Z | Frequency 3 |

TABLE 4b
Frequencies corresponding to the plurality
of moments of the cell #A

| Moment | Frequency |
|---|---|
| Moment #A | Frequency 2 |
| Moment #F | Frequency 3 |
| Moment #Z | Frequency 4 |

In Table 4a, the cell #A and the cell #B have a same PCI and frequency (which is the frequency 1) before the moment #A, and the cell #B becomes a first-order neighboring cell of the cell #A at the moment #A. The frequency of the cell #A needs to be switched from the frequency 1 to the frequency 2 at the moment #A or before the moment #A. The cell #A and a cell #D have a same PCI and frequency (which is the frequency 2) before the moment #F, and the cell #D becomes a first-order neighboring cell of the cell #A at the moment #F. The frequency of the cell #A needs to be changed or updated from the frequency 2 to the frequency 3 at the moment #F or before the moment #F. The cell #A and a cell #G have a same PCI and frequency (which is the frequency 3) before the moment #Z, and the cell #G becomes a first-order neighboring cell of the cell #A at the moment #Z. The frequency of the cell #A needs to be changed or updated from the frequency 3 to the frequency 4 at the moment #Z or before the moment #Z.

In Table 4b, the frequency of the cell #A at the moment #A is the frequency 2, the frequency of the cell #A at the moment #F is the frequency 3, and the frequency of the cell #A at the moment #Z is the frequency 4. Frequencies corresponding to different moments are indicated, so that a frequency of the first cell and a frequency of a neighboring cell can be distinguished from each other. This can avoid a conflict between a plurality of neighboring cells having a same cell identifier, and avoid a cell handover failure caused by a cell identifier conflict or cell identifier confusion.

Table 4a and Table 4b are two example expressions, and another expression is not limited in this embodiment of this application.

It should be understood that the configuration information #B may include one updated frequency and one update moment (refer to Table 3), or may include a plurality of updated frequencies and a plurality of update moments (refer to Table 4).

The network device #A may send content shown in Table 4 as the configuration information #B to the terminal device #A in the coverage range of the cell #A, and the terminal device #A updates or changes the frequency based on time shown in Table 4.

In a possible implementation, the configuration information #B sent by the network device #A to the terminal device #A may be configuration information that is sent by a network device corresponding to a neighboring cell of the cell #A and that is received by the network device #A. This is further described below.

In a possible implementation, the network device #A may send the configuration information #B to the network device corresponding to the neighboring cell of the cell #A. In this way, a terminal device in a coverage range of the neighboring cell can measure the cell #A based on the updated frequency of the cell #A and communicate with a network device of the cell #A. This is further described below.

In FIG. 2, the measurement result reported by the terminal to the network device may include a PCI and a frequency of a cell. In this case, the network device may determine, based on the measurement result, a target cell to which the terminal is to be handed over, and trigger the terminal to be handed over from the cell on which the terminal camps to the target cell.

Specifically, the source gNB determines, according to a handover principle, the target cell to which the terminal is to be handed over. For example, a cell with a strongest signal may be selected as the target cell for handover. Because frequencies of cells are different, the source gNB distinguishes a specific target cell based on the frequency, so that a conflict problem does not occur.

In addition, identification information that is of the target cell and that is sent by the source gNB to the terminal may include a PCI and a frequency. In this way, a case in which the terminal confuses adjacent cells having a same PCI can be avoided.

The frequency of the first cell is changed at or before a moment at which a cell that has a same PCI (or same PCI mod N) as the first cell becomes a neighboring cell of the first cell, so that in this embodiment of this application, the first cell and the cell that has the same PCI as the first cell can be distinguished from each other based on different frequencies of the cells. In this way, a conflict between a plurality of neighboring cells having a same cell identifier can be avoided, and a cell handover failure caused by the cell identifier conflict or cell identifier confusion can be avoided.

It should be understood that in the technical solution shown in FIG. 6, a polarization direction of the cell #A may be the same as or different from a polarization direction of the cell #B. This is not limited in this embodiment of this application.

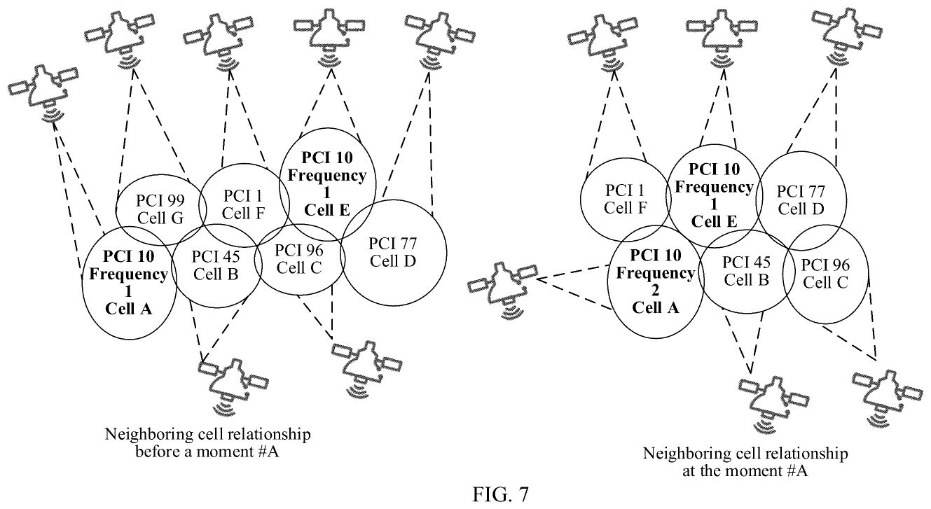

FIG. 7 is an example description of the technical solution shown in FIG. 6.

FIG. 7 is another diagram of avoiding a PCI conflict between first-order neighboring cells according to an embodiment of this application. In FIG. 7, the cell #A is a cell A, the cell #B is a cell E, a PCI of the cell A and a PCI of the cell E are both 10, and a frequency of the cell A and a frequency of the cell E are both the frequency 1. Before the moment #A, the cell A and the cell E do not meet the first-order neighboring cell relationship. At the moment #A, the cell A and the cell E meet the first-order neighboring cell relationship. A network device corresponding to the cell A needs to change the frequency of the cell A from the frequency 1 to the frequency 2 at the moment #A or before the moment #A. At the moment #A, the cell A and the cell E meet the first-order neighboring cell relationship, but the frequency of the cell A and the frequency of the cell E are different. This avoids the PCI conflict between the first-order neighboring cells.

The technical solution shown in FIG. 6 is also applicable to a scenario in which the cell #A and the cell #B meet a second-order neighboring cell relationship or a multi-order neighboring cell relationship. Specific content is consistent with the foregoing content. Details are not described herein again.

In a possible implementation, the configuration information #B shown in FIG. 6 may be sent by the network device to the terminal device in the broadcast or multicast manner, for example, included in at least one of the following broadcast information: the SIB, OSI, the MIB, and the like. In this way, a case in which different resources are scheduled for different terminal devices for a purpose of sending the foregoing signaling can be avoided, thereby reducing signaling overheads of scheduled resources and reducing system scheduling complexity.

In a possible implementation, when sending the configuration information #B to the terminal device in an RRC connection setup phase and a subsequent communication process, the network device may send the configuration information #B by using a unicast/multicast message, for example, include the configuration information #B in at least one of RRC signaling (for example, an RRC setup message, RRC reconfiguration signaling, and RRC resume signaling), DCI, group DCI, a MAC CE, and a TAC, or send the configuration information #B to the terminal device in a unicast or multicast manner along with data transmission or in a separately allocated PDSCH bearer. In this way, a message related to frequency update of a cell on which the terminal device camps/neighboring cell may be timely sent to the terminal device without waiting for update latency of a broadcast message (where the broadcast message is periodically updated). This is more timely.

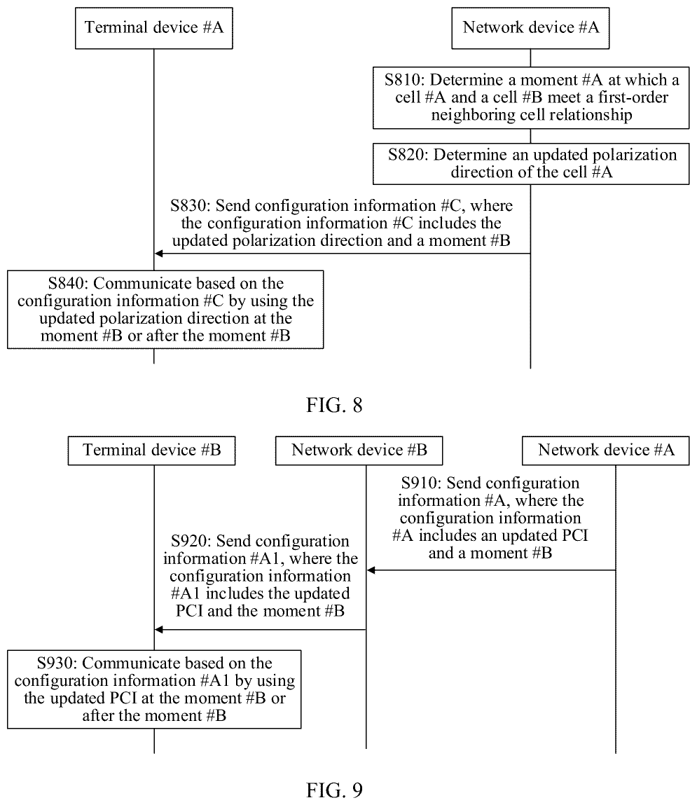

FIG. 8 is a schematic flowchart of another communication method according to an embodiment of this application. The method includes the following steps.

S810: Same as step S410.

S820: A network device #A determines an updated polarization direction of a cell #A.

To avoid a problem that when the cell #A and a cell #B meet a first-order neighboring cell relationship, a PCI conflict between first-order neighboring cells occurs because the cells have a same PCI, the network device #A may update a polarization direction of the cell #A, in other words, determine the updated polarization direction of the cell #A. The updated polarization direction can enable the cell #A and the cell #B to be distinguished from each other based on polarization directions.

S830: The network device #A sends configuration information #C to a terminal device #A, where the configuration information #C includes the updated polarization direction and a moment #B.

Correspondingly, the terminal device #A receives the configuration information #C sent by the network device #A. The terminal device #A is located in a coverage range of the cell #A.

In a possible implementation, the configuration information #C may be a polarization direction update information element (polarization direction update information element). The polarization direction update information element includes the updated polarization direction and the moment #B.

It should be understood that the moment #B may be a moment #A or a moment before the moment #A. The moment #B represents a moment at which the polarization direction of the cell #A is changed. The polarization direction of the cell #A may be changed at the moment #A or earlier than the moment #A.

For example, a structure of the polarization direction update information element is shown in Table 5.

TABLE 5
Polarization direction update information element

| Polarization direction_update: | |
|---|---|
| Polarization direction_value | Integer (integer) |
| TimeInfo_UTC | Integer (integer) |

Alternatively, a structure of the polarization direction update information element may be shown as follows:

-- ASN1START
-- TAG-BWP-START
Polarization direction _update = SEQUENCE {
Polarization direction_value INTEGER (0..1),
TimeInfo_UTC INTEGER (0..549755813887)
}
-- TAG-BWP-STOP
-- ASN1STOP

Polarization direction_value represents the updated polarization direction, and may be represented by using at least one bit. For example, one bit is used. “1” represents a left rotation direction, and “0” represents a right rotation direction; or “1” represents a right rotation direction, and “0” represents a left rotation direction. For example, two bits are used. “11” represents a left rotation direction, and “00” represents a right rotation direction; or “10” represents a right rotation direction, and “01” represents a left rotation direction. TimeInfo_UTC represents the moment #B. For descriptions of the moment #B, refer to the foregoing content. Details are not described herein again.

The updated polarization direction is directly carried in the configuration information #C, so that in this embodiment of this application, a terminal device can directly obtain an updated polarization direction of a first cell.

In a possible implementation, the configuration information #C includes an indication bit. The indication bit indicates the terminal device to update a polarization direction of the first cell. The indication bit may include one or more bits. For example, a bit “1” indicates to update the polarization direction of the first cell, or a bit “0” indicates not to update the polarization direction of the first cell. In this way, signaling overheads can be reduced.

In a possible implementation, the configuration information #C includes update time information. After receiving the configuration information #C, the terminal device updates the polarization direction of the first cell by default. In this way, the signaling overheads can be reduced.

The network device #A may send the configuration information #C to the terminal device #A in the coverage range of the cell #A in a broadcast/multicast/separate sending manner. In this way, a case in which different resources are scheduled for different terminal devices for a purpose of sending the foregoing configuration information can be avoided, thereby reducing signaling overheads of scheduled resources and reducing system scheduling complexity.

S840: The terminal device #A communicates based on the configuration information #C by using the updated polarization direction at the moment #B or after the moment #B.

Alternatively, the terminal device #A starts to use the updated polarization direction at the moment #B or after the moment #B to communicate.

Specifically, the terminal device #A measures a cell of the network device #A by using the updated polarization direction, and communicates with the network device A.

The polarization direction shown in FIG. 8 may be understood as the first identification information shown in FIG. 3. The updated polarization direction shown in FIG. 8 may be understood as the first identification update information shown in FIG. 3. The moment #B shown in FIG. 8 may be understood as the first update moment shown in FIG. 3.

In the technical solution shown in FIG. 8, the network device #A may determine, based on prediction, a polarization direction corresponding to another moment of the cell #A. In this way, a plurality of polarization directions in a period of time can be determined by using one piece of configuration information. In this way, frequently sending the configuration information for a plurality of times can be avoided, and signaling resources can be saved. For example, polarization directions corresponding to a plurality of periods of time of the cell #A are shown in Table 6a. Polarization directions corresponding to a plurality of moments of the cell #A are shown in Table 6b. A PCI of the cell #B, a PCI of a cell #D, a PCI of a cell #G, and a PCI of the cell #A are all the same.

TABLE 6a
Polarization directions corresponding to the
plurality of periods of time of the cell #A

| Period of time | Polarization direction |
|---|---|
| Before the moment #A | Left rotation direction |
| Moment #A to moment #F | Right rotation direction |
| Moment #F to moment #Z | Left rotation direction |

TABLE 6b
Polarization directions corresponding to the
plurality of moments of the cell #A

| Moment | Polarization direction |
|---|---|
| Moment #A | Right rotation direction |
| Moment #F | Left rotation direction |
| Moment #Z | Right rotation direction |

In Table 6a, the cell #A and the cell #B have a same polarization direction (which is the left rotation direction) before the moment #A, and the cell #B becomes a first-order neighboring cell of the cell #A at the moment #A. The polarization direction of the cell #A needs to be changed or updated from the left rotation direction to the right rotation direction at the moment #A or before the moment #A. The cell #A and the cell #D have a same polarization direction (which is the right rotation direction) from the moment #A to the moment #F, and the cell #D becomes a first-order neighboring cell of the cell #A at the moment #F. The polarization direction of the cell #A needs to be changed or updated from the right rotation direction to the left rotation direction at the moment #F or before the moment #F. The cell #A and the cell #G have a same polarization direction (which is the left rotation direction) from the moment #F to the moment #Z, and the cell #G becomes a first-order neighboring cell of the cell #A at the moment #Z. Therefore, the polarization direction of the cell #A needs to be changed or updated from the left rotation direction to the right rotation direction at the moment #Z or before the moment #Z.

In Table 6b, the polarization direction of the cell #A at the moment #A is the right rotation direction, the polarization direction of the cell #A at the moment #F is the left rotation direction, and the polarization direction of the cell #A at the moment #Z is the right rotation direction. Polarization directions corresponding to different moments are indicated, so that in this embodiment of this application, the polarization direction of the first cell and a polarization direction of a neighboring cell can be distinguished from each other. This can avoid a conflict between a plurality of neighboring cells having a same cell identifier, and avoid a cell handover failure caused by a cell identifier conflict or cell identifier confusion.

Table 6a and Table 6b are two example expressions, and another expression is not limited in this embodiment of this application.

It should be understood that the configuration information #C may include one updated polarization direction and one update moment (refer to Table 5), or may include a plurality of updated polarization directions and a plurality of update moments (refer to Table 6).

The network device #A may send content shown in Table 6 to a terminal device in the coverage range of the cell #A, and the terminal device updates or changes the polarization direction based on time information shown in Table 6.

In a possible implementation, the configuration information #C sent by the network device #A to the terminal device #A may be configuration information that is sent by a network device corresponding to a neighboring cell of the cell #A and that is received by the network device #A. This is further described below.

In a possible implementation, the network device #A may send the configuration information #C to the network device corresponding to the neighboring cell of the cell #A. In this way, a terminal device in a coverage range of the neighboring cell can measure the cell #A based on the updated polarization direction of the cell #A and communicate with a network device of the cell #A. This is further described below.

It should be understood that in the technical solution shown in FIG. 8, a frequency of the cell #A may be the same as or different from a frequency of the cell #B. This is not limited in this embodiment of this application.

It should be understood that the configuration information #C shown in FIG. 8 may be included in at least one of the following broadcast information: a SIB, an OSI, a MIB, and the like, and is sent by a network device to a terminal device in the broadcast or multicast manner. In this way, a case in which different resources are scheduled for different terminal devices for a purpose of sending the foregoing signaling can be avoided, thereby reducing signaling overheads of scheduled resources and reducing system scheduling complexity.

In a possible implementation, when sending the configuration information #C to the terminal device in an RRC connection setup phase and a subsequent communication process, the network device may send the configuration information #C by using a unicast/multicast message, for example, include the configuration information #C in at least one of RRC signaling, DCI, group DCI, a MAC CE, and a TAC, or send the configuration information #C to the terminal device in a unicast or multicast manner along with data transmission or in a separately allocated PDSCH bearer. In this way, a message related to polarization direction update of a cell on which the terminal device camps/neighboring cell may be timely sent to the terminal device without waiting for update latency of a broadcast message (where the broadcast message is periodically updated). This is more timely.

In a possible implementation, in FIG. 2, the measurement result reported by the terminal to the network device may include a PCI and a polarization direction of a cell. In this case, the network device may determine, based on the measurement result, a target cell to which the terminal is to be handed over, and trigger the terminal to be handed over from the cell on which the terminal camps to the target cell.

Specifically, the source gNB determines, according to a handover principle, the target cell to which the terminal is to be handed over. For example, a cell with a strongest signal may be selected as the target cell for handover. Because polarization directions of cells are different, the source gNB distinguishes a specific target cell based on the polarization direction, so that a conflict problem does not occur.

In addition, identification information that is of the target cell and that is sent by the source gNB to the terminal may include a PCI and a polarization direction. In this way, a case in which the terminal confuses adjacent cells having a same PCI can be avoided.

The polarization direction of the first cell is changed at or before a moment at which a cell that has a same PCI (or same PCI mod N) as the first cell becomes a neighboring cell of the first cell, so that in this embodiment of this application, the first cell and the cell that has the same PCI as the first cell can be distinguished from each other based on different polarization directions of the cells. In this way, a conflict between a plurality of neighboring cells having a same cell identifier can be avoided, and a cell handover failure caused by the cell identifier conflict or cell identifier confusion can be avoided.

In embodiments of this application, the technical solutions shown in FIG. 4, FIG. 6, and FIG. 8 may mutually form a new technical solution.

For example, configuration information sent by the network device #A to the cell #A may include an updated PCI and an updated frequency, may include an updated PCI and an updated polarization direction, may include an updated polarization direction and an updated frequency, or may include an updated PCI, an updated frequency, and an updated polarization direction. For specific content, refer to the foregoing descriptions. Details are not described herein again.

FIG. 9 is a schematic flowchart of still another communication method according to an embodiment of this application. The method includes the following steps.

S910: A network device #A sends configuration information #A to a network device #B.

Correspondingly, the network device #B receives the configuration information #A sent by the network device #A.

Specifically, after determining to update a PCI of a cell #A of the network device #A, the network device #A sends the configuration information #A to a network device corresponding to a neighboring cell of the cell #A. For example, a cell (for example, a cell #C) corresponding to the network device #B is a neighboring cell of the cell #A, and the network device #B obtains the configuration information #A.

It should be understood that the network device #B may be understood as a third communication apparatus, and the network device #A may be understood as a second communication apparatus.

S920: The network device #B sends configuration information #A1 to a terminal device #B.

Correspondingly, the terminal device #B receives the configuration information #A1 sent by the network device #B.

It should be understood that the configuration information #A1 sent by the network device #B to the terminal device #B may be the configuration information #A, or may be configuration information obtained by adding some information to the configuration information #A. For example, the added information may be a PCI that is not updated of the cell #A or a cell identifier (cell identifier) of a cell whose PCI is changed.

It should be understood that the terminal device #B is located in a coverage range of a cell #C. The cell #C is a neighboring cell of the cell #A, and the network device #B is a network device corresponding to the cell #C.

For example, the configuration information #A1 is a neighboring cell PCI update information element (neighbour PCI update information element). A structure of the neighbour PCI update information element is shown in Table 7.

TABLE 7
Neighbour PCI update information element

| PCI_neighbour_update: | |
|---|---|
| PCI_value_old | Integer (integer) |
| PCI_value_new | Integer (integer) |
| TimeInfo_UTC | Integer (integer) |

Alternatively, a structure of the neighbour PCI update information element may be shown as follows:

-- ASN1START
-- TAG-BWP-START
PCI_neighbour_update = SEQUENCE {
PCI_value_old INTEGER (0..1007),
PCI_value_new INTEGER (0..1007),
TimeInfo_UTC INTEGER (0..549755813887)
}
-- TAG-BWP-STOP
-- ASN1STOP

PCI_value_old represents a value of a PCI that is not updated, for example, may be represented by using 10 bits. PCI_value_new represents a value of an updated PCI, for example, may be represented by using 10 bits. After receiving the configuration information #A1, the terminal device #B may obtain the following information: A cell whose PCI is PCI_value_old updates the PCI to PCI_value_new after time TimeInfo_UTC.

In a possible implementation, the configuration information #A1 may include a cell identifier (cell identifier), the updated PCI, and information about an update moment. The cell identifier represents a cell whose PCI is updated/switched, for example, may be represented by using 36 bits. The structure may be shown as follows:

-- ASN1START
-- TAG-BWP-START
PCI_neighbour_update = SEQUENCE {
CellIdentity INTEGER (0..68719476735),
PCI_value_new INTEGER (0..1007),
TimeInfo_UTC INTEGER (0..549755813887)
}
-- TAG-BWP-STOP
-- ASN1STOP

The cell identifier may include a base station identifier and a cell identifier. For example, a cell identifier in an NR communication system includes a gNodeB ID and a cell identifier (cell ID). A length of the cell identifier is 36 bits. In the NR communication system, a maximum quantity of cells supported by using the cell identifier is 6.87e¹⁰. For another example, a cell identifier in an evolution universal mobile telecommunications system terrestrial radio access network (evolution universal mobile telecommunications system terrestrial radio access network, E-UTRAN) communication system includes an eNodeB ID and a cell identifier. A length of the cell identifier is 28 bits. Therefore, in the E-UTRAN communication system, a maximum quantity of cells supported by using the cell identifier is 2.68e⁸. Each cell has a corresponding cell identifier, a maximum length of the cell identifier is 14 bits, and a maximum quantity of non-repeated cells supported by using the cell identifier is 16384.

It should be understood that the cell identifier may be included in cell global identifier (cell global identifier, CGI) information. The cell global identifier includes a mobile country code (mobile country code, Mcc), a mobile network code (mobile network code, Mnc), a base station identifier, and a cell identifier. For example, in the NR communication system, the base station identifier is the gNodeB ID. In the E-UTRAN communication system, the base station identifier is the eNodeB ID. A length of the CGI is 60 bits, and a maximum quantity of supported by using the CGI is 1.529e¹⁸.

Cells are distinguished from each other by using cell identities. In this way, in this embodiment of this application, a terminal device in a coverage range of a cell corresponding to the network device #B can determine a cell whose PCI is updated, to avoid confusion.

The terminal device #B may read a CGI and a cell identifier of the cell #A by using a SIB message. Therefore, the cell identifier may be replaced with the CGI, the gNB ID, or the cell ID. An eNB and a gNB may be entities in a 4G system, a 5G system, or a future communication system.

S930: The terminal device #B communicates based on the configuration information #A1 by using the updated PCI at a moment #B or after the moment #B.

Specifically, the terminal device #B measures a cell of the network device #A by using the updated PCI, and communicates with the network device #A.

In the technical solution shown in FIG. 9, moment information in the configuration information #A1 may be standard time information or timer information. If the moment information is the timer information, the network device #B may determine, based on timer information sent by the network device #A, a length of a timer that is sent to the cell #C.

In a possible implementation, a length of a timer that is in configuration information and that is sent by the network device #A to a terminal in a coverage range of the cell #A is greater than a length of a timer that is in configuration information and that is sent by the network device #B to a terminal in a coverage range of the cell #C. The network device #B may determine a length of a timer in the configuration information #A1 based on the length of the timer that is in the configuration information #A and that is sent by the network device #A and transmission latency between the network device #A and the network device #B. In this way, the terminal device in the coverage range of the cell corresponding to the network device #B and a terminal device in a coverage range of a first cell corresponding to the network device #A may synchronously update identification information of cells to which the terminal devices belong. If the moment information is the standard time information, standard time that is in configuration information and that is sent by the network device #A to the cell #A is the same as standard time that is in configuration information and that is sent by the network device #B to the cell #C.

According to the foregoing technical solution, in this embodiment of this application, a terminal device in a coverage range of a neighboring cell of the first cell can measure the first cell by using updated identification information, and communicate with a network device corresponding to the first cell.

It should be understood that in addition to sending the configuration information #A to the network device #B, the network device #A may further send configuration information #B and configuration information #C to the network device #B. Specific solutions are basically consistent with the solution shown in FIG. 9. Details are not described herein again.

For example, when receiving the configuration information #B sent by the network device #A, the network device #B sends configuration information #B1 to the terminal device #B. For example, the configuration information #B1 may be a neighboring cell frequency update information element (neighbour frequency update information element). A structure of the neighbour frequency update information element is shown in Table 8.

TABLE 8
Neighbour frequency update information element

| Frequency_neighbour_update: | |
|---|---|
| Cell identifier | Integer (integer) |
| Frequency_info_new | Frequency information |
| | (Frequency_info_new) |
| TimeInfo_UTC | Integer (integer) |

Alternatively, a structure of the neighbour frequency update information element may be shown as follows:

-- ASN1START
-- TAG-BWP-START
Frequency_neighbour_update = SEQUENCE {
CellIdentity INTEGER (0..68719476735),
Frequency_info_new,
TimeInfo_UTC INTEGER (0..549755813887)
}
-- TAG-BWP-STOP
-- ASN1STOP

Cell identifier represents a cell identifier of a cell whose frequency is updated/switched, for example, may be represented by using 36 bits. Frequency_info_new represents updated frequency information of a cell. After receiving the configuration information #B1, the terminal device #B may obtain the following information: A cell whose cell identifier is CellIdentity shown in Table 8 updates a frequency to Frequency_info_new after time TimeInfo_UTC. For descriptions of the cell identifier, refer to the foregoing descriptions. Details are not described herein again.

In a possible implementation, in addition to receiving configuration information that is determined by the network device #A and that is sent by the network device #A, the network device #B may also send, to the network device #A, configuration information that is of the cell #C and that is determined by the network device #B. In addition, the network device #A sends, to a terminal device in a coverage range of the cell #A, the configuration information received by the network device #B. For specific content, refer to the foregoing content. Details are not described herein again.

In a possible implementation, when corresponding to a plurality of cells, the network device #A may send PCI information of the plurality of cells of the network device #A to the network device #B. Examples are shown in Table 9a and Table 9b.

TABLE 9a
PCIs corresponding to a plurality of periods
of time of a plurality of cells corresponding
to the network device #A

| | Cell | | |
|---|---|---|---|
| Time | Cell A | Cell B | Cell C |
| T0 to T1 | 10 | 55 | 89 |
| T1 to T2 | 6 | | 86 |
| T2 to T3 | 8 | 52 | |

TABLE 9b
PCIs corresponding to a plurality of moments
of the plurality of cells corresponding
to the network device #A

| | Cell | | |
|---|---|---|---|
| Time | Cell A | Cell B | Cell C |
| T1 | 6 | 55 | 86 |
| T2 | 8 | 52 | |
| T3 | 10 | | |

It should be understood that Table 9a and Table 9b are two example expressions, and another expression is not limited in this embodiment of this application.

After receiving the foregoing information, the network device #B sends the information to the terminal device in the coverage range of the cell corresponding to the network device #B, and the terminal device in the coverage range of the cell corresponding to the network device #B updates the information, to perform corresponding communication.

In a possible implementation, the network device #A may also send frequency information of the plurality of cells of the network device #A to the network device #B. For example, refer to Table 10a and Table 10b.

TABLE 10a
Frequencies corresponding to the plurality of
periods of time of the plurality of cells
corresponding to the network device #A

| | Cell | | |
|---|---|---|---|
| Time | Cell A | Cell B | Cell C |
| T0 to T1 | Frequency 1 | Frequency 3 | Frequency 2 |
| T1 to T2 | Frequency 2 | | Frequency 3 |
| T2 to T3 | Frequency 3 | Frequency 2 | |

TABLE 10b
Frequencies corresponding to the plurality
of moments of the plurality of cells
corresponding to the network device #A

| | Cell | | |
|---|---|---|---|
| Time | Cell A | Cell B | Cell C |
| T1 | Frequency 2 | Frequency 3 | Frequency 3 |
| T2 | Frequency 3 | Frequency 2 | |
| T3 | Frequency 1 | | |

It should be understood that Table 10a and Table 10b are two example expressions, and another expression is not limited in this embodiment of this application.

After receiving the foregoing information, the network device #B sends the information to the terminal device in the coverage range of the cell corresponding to the network device #B, and the terminal device in the coverage range of the cell corresponding to the network device #B updates the information, to perform corresponding communication.

The network device #A may also send polarization direction information of the plurality of cells of the network device #A to the network device #B. For example, refer to Table 11a and Table 11b.

TABLE 11a
Polarization directions corresponding to the plurality of
periods of time of the plurality of cells corresponding
to the network device #A

| | Cell | | |
|---|---|---|---|
| Time | Cell A | Cell B | Cell C |
| T0 to T1 | Left rotation | Right rotation | Right rotation |
| | direction | direction | direction |
| T1 to T2 | Right rotation | | Left rotation |
| | direction | | direction |
| T2 to T3 | Right rotation | Left rotation | |
| | direction | direction | |

TABLE 11b
Polarization directions corresponding to the plurality
of moments of the plurality of cells corresponding
to the network device #A

| | Cell | | |
|---|---|---|---|
| Time | Cell A | Cell B | Cell C |
| T1 | Right rotation | Right rotation | Left rotation |
| | direction | direction | direction |
| T2 | Right rotation | Left rotation | |
| T3 | direction | direction | |

It should be understood that Table 11a and Table 11b are two example expressions, and another expression is not limited in this embodiment of this application.

After receiving the foregoing information, the network device #B sends the information to the terminal device in the coverage range of the cell corresponding to the network device #B, and the terminal device in the coverage range of the cell corresponding to the network device #B updates the information, to perform corresponding communication.

Technical solutions shown in FIG. 4 to FIG. 9 may alternatively be mutually combined into a new technical solution. This is not specifically limited in embodiments of this application.

It should be understood that the technical solutions shown in FIG. 4 to FIG. 9 may be considered as support for the technical solution shown in FIG. 3 or another expression of the technical solution shown in FIG. 3. This is not limited in embodiments of this application.

The foregoing describes the method embodiments of embodiments of this application, and the following describes corresponding apparatus embodiments.

To implement functions in the methods provided in the foregoing embodiments of this application, both the terminal device and the network device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

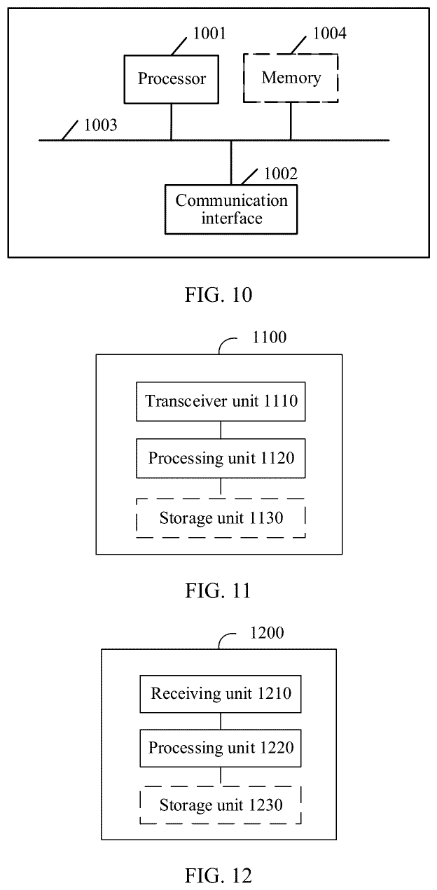

FIG. 10 is a diagram of a communication apparatus according to an embodiment of this application. The communication apparatus includes a processor 1001 and a communication interface 1002. The processor 1001 and the communication interface 1002 are connected to each other through a bus 1003. The communication apparatus shown in FIG. 10 may be a network device or a terminal device.

Optionally, the communication apparatus further includes a memory 1004.

The memory 1002 includes but is not limited to a random access memory (random access memory, RAM), a read-only memory (read-only memory, ROM), an erasable programmable read-only memory (erasable programmable read-only memory, EPROM), or a compact disc read-only memory (compact disc read-only memory, CD-ROM). The memory 1002 is configured to store related instructions and related data.

The processor 1001 may be one or more central processing units (central processing units, CPUs). When the processor 1001 is one CPU, the CPU may be a single-core CPU or a multi-core CPU.

When the communication apparatus is the network device, for example, a network device #A, the processor 1001 in the communication apparatus is configured to read a computer program or instructions stored in the memory 1002, for example, perform the following operations.

First configuration information of a first cell of a second communication apparatus is determined, where the first configuration information includes first identification update information and information about a first update moment of the first cell. The first identification update information is used to determine first identification information used by the first cell at the first update moment or after the first update moment.

The first configuration information is sent.

Alternatively, for example, the processor 1001 in the communication apparatus performs the following operations.

A moment #A at which a cell #A and a cell #B meet a first-order neighboring cell relationship is determined. An updated PCI of the cell #A is determined. Configuration information #A is sent to a terminal device #A.

It should be understood that the foregoing content is merely used as an example for description. When the communication apparatus is the network device #A, the communication apparatus is responsible for performing methods or steps related to the network device #A in the foregoing method embodiments. When the communication apparatus is a network device #B, the communication apparatus is responsible for performing methods or steps related to the network device #B in the foregoing method embodiments.

When the communication apparatus is the terminal device, for example, the terminal device #A, the processor 1001 in the communication apparatus is configured to read program code stored in the memory 1002, for example, perform the following operations. The configuration information #A is received. Communication is performed based on the configuration information #A by using the updated PCI at a moment #B or after a moment #B.

It should be understood that the foregoing content is merely used as an example for description. When the communication apparatus is the terminal device #A, the communication apparatus is responsible for performing methods or steps related to the terminal device #A in the foregoing method embodiments. When the communication apparatus is a terminal device ##B, the communication apparatus is responsible for performing methods or steps related to the terminal device #B in the foregoing method embodiments.

It should be understood that the foregoing descriptions are merely example descriptions. For specific content, refer to content shown in the foregoing method embodiments. In addition, for implementation of operations in FIG. 10, refer to corresponding descriptions of the method embodiments shown in FIG. 3 to FIG. 9.

FIG. 11 is a diagram of another communication apparatus according to an embodiment of this application. The communication apparatus may be used in a network device, and may be configured to implement methods in the foregoing embodiments. The communication apparatus includes a transceiver unit 1110 and a processing unit 1120. The following describes the transceiver unit 1110 and the processing unit 1120 by using examples.

When the communication apparatus is a network device #A, for example, the transceiver unit 1110 is configured to send configuration information #A. The processing unit 1120 is configured to: determine the configuration information #A; determine a moment #A at which a cell #A and a cell #B meet a first-order neighboring cell relationship; and determine an updated PCI of the cell #A. The transceiver unit 1110 may be further configured to receive configuration information sent by another network device.

When the communication apparatus is a network device #B, for example, the transceiver unit 1110 is configured to: receive the configuration information #A; and send configuration information #A1. The processing unit #1120 is configured to determine the configuration information #A1.

It should be understood that the foregoing content is merely used as an example for description. When the communication apparatus is the network device #A, the communication apparatus is responsible for performing methods or steps related to the network device #A in the foregoing method embodiments. When the communication apparatus is the network device #B, the communication apparatus is responsible for performing methods or steps related to the network device #B in the foregoing method embodiments.

In a possible implementation, the communication apparatus further includes a storage unit 1130. The storage unit 1130 is configured to store a program or code used to perform the foregoing methods.

In addition, for implementation of operations in FIG. 11, refer to corresponding descriptions of the methods shown in the foregoing embodiments. Details are not described herein again.

FIG. 12 is a diagram of still another communication apparatus according to an embodiment of this application. The communication apparatus may be used in a terminal device, and may be configured to implement methods in the foregoing embodiments. The communication apparatus includes a receiving unit 1210 and a processing unit 1220. The following describes the receiving unit 1210 and the processing unit 1220 by using examples.

When the communication apparatus is a terminal device #A, for example, the receiving unit 1210 is configured to receive configuration information #A. The processing unit 1220 is configured to communicate based on the configuration information #A by using an updated PCI at a moment #B or after a moment #B.

When the communication apparatus is a terminal device #B, for example, the receiving unit 1210 is configured to receive configuration information #A1. The processing unit 1220 is configured to communicate based on the configuration information #A1 by using an updated PCI at a moment #B or after a moment #B.

It should be understood that the foregoing content is merely used as an example for description. When the communication apparatus is the terminal device #A, the communication apparatus is responsible for performing methods or steps related to the terminal device #A in the foregoing method embodiments. When the communication apparatus is the terminal device #B, the communication apparatus is responsible for performing methods or steps related to the terminal device #B in the foregoing method embodiments.

In a possible implementation, the communication apparatus further includes a storage unit 1230. The storage unit 1230 is configured to store a program or code used to perform the foregoing methods.

In addition, for implementation of operations in FIG. 12, refer to corresponding descriptions of the methods shown in the foregoing embodiments. Details are not described herein again.

It should be understood that the apparatus embodiments shown in FIG. 10 to FIG. 12 are used to implement content described in FIG. 3 to FIG. 9 in the foregoing method embodiments. Therefore, for specific performing steps and methods of the apparatuses shown in FIG. 10 to FIG. 12, refer to the content described in the foregoing method embodiments.

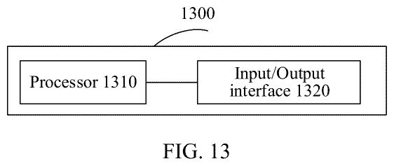

FIG. 13 is a diagram of yet another communication apparatus according to an embodiment of this application. The communication apparatus may be configured to implement functions of the first communication apparatus, the second communication apparatus, and the third communication apparatus in the foregoing methods. The apparatus may be a communication apparatus or a chip in the communication apparatus.

The communication apparatus includes an input/output interface 1320 and a processor 1310. The input/output interface 1320 may be an input/output circuit. The processor 1310 may be a signal processor, a chip, or another integrated circuit that can implement the methods in this application. The input/output interface 1320 is configured to input or output a signal or data.

For example, when the apparatus is a first communication apparatus, the input/output interface 1320 is configured to receive first configuration information. For example, when the apparatus is a second communication apparatus, the input/output interface 1320 is configured to send first configuration information. The processor 1310 is configured to perform some or all steps of any one of the methods provided in embodiments of this application. When the apparatus is a third communication apparatus, the output/output interface 1320 is configured to send second configuration information.

For example, when the apparatus is the first communication apparatus, the apparatus is configured to perform steps performed by the first communication apparatus in the possible implementations in the foregoing method embodiments. For example, the processor 1310 is configured to communicate based on the first configuration information by using first identification update information at a first update moment or after a first update moment. When the apparatus is the second communication apparatus, the apparatus is configured to perform steps performed by the second communication apparatus in the possible implementation methods in the foregoing method embodiments. For example, the processor 1310 is configured to determine the first configuration information. When the apparatus is the third communication apparatus, the processor 1310 is configured to determine the second configuration information.

In a possible implementation, the processor 1310 executes instructions stored in a memory, to implement functions implemented by the first communication apparatus, the second communication apparatus, or a terminal.

Optionally, the communication apparatus further includes the memory.

Optionally, the processor and the memory are integrated together.

Optionally, the memory is outside the communication apparatus.

In a possible implementation, the processor 1310 may be a logic circuit, and the processor 1310 inputs/outputs a message or signaling through the input/output interface 1320. The logic circuit may be a signal processor, a chip, or another integrated circuit that can implement the methods in embodiments of this application.

It should be understood that the foregoing descriptions of the apparatus in FIG. 13 are used as examples for description. The apparatus can be configured to perform the methods in the foregoing embodiments. For specific content, refer to descriptions in the foregoing method embodiments. Details are not described herein again.

An embodiment of this application further provides a chip, including a processor, configured to: invoke, from a memory, instructions stored in the memory; and run the instructions, to enable a communication device on which the chip is installed to perform the methods in the foregoing examples.

An embodiment of this application further provides another chip, including an input interface, an output interface, and a processor. The input interface, the output interface, and the processor are connected through an internal connection channel. The processor is configured to execute code in a memory. When the code is executed, the processor is configured to perform the methods in the foregoing examples. Optionally, the chip further includes the memory. The memory is configured to store a computer program or the code.

An embodiment of this application further provides a processor, configured to be coupled to a memory, and configured to perform the method and functions of the first communication apparatus or the second communication apparatus in any one of the foregoing embodiments.

Another embodiment of this application provides a computer program product including instructions. When the computer program product runs on a computer, the methods in the foregoing embodiments are implemented.

An embodiment of this application further provides a computer program. When the computer program is run in a computer, the methods in the foregoing embodiments are implemented.

Another embodiment of this application provides a computer-readable storage medium. The computer-readable storage medium stores a computer program. When the computer program is executed by a computer, the methods in the foregoing embodiments are implemented.

In the descriptions of embodiments of this application, unless otherwise specified, “a plurality of” means two or more than two. “At least one of the following items (pieces)” or a similar expression thereof indicates any combination of these items, including any combination of singular items (pieces) or plural items (pieces). For example, at least one item (piece) of a, b, or c may represent: a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, words such as “example” or “for example” represents giving an example, an illustration, or a description.

Any embodiment or design scheme described as the “example” or “for example” in embodiments of this application should not be construed as being more preferred or more advantageous than another embodiment or design scheme. Exactly, use of the words such as “example” or “for example” is intended to present a related concept in a specific manner for ease of understanding.

Unless otherwise specified, “/” in the descriptions of embodiments of this application represents an “or” relationship between associated objects. For example, A/B may represent A or B. In this application, “and/or” represents only an association relationship for describing associated objects and represents that three relationships may exist. For example, A and/or B may represent the following three cases: Only A exists, both A and B exist, and only B exists, where A and B may be singular or plural.

It should be understood that “one embodiment” or “an embodiment” mentioned throughout this specification means that particular features, structures, or characteristics related to the embodiment are included in at least one embodiment of this application.

Therefore, “in one embodiment” or “in an embodiment” appearing throughout the specification does not necessarily refer to a same embodiment. In addition, these particular features, structures, or characteristics may be combined in one or more embodiments in any appropriate manner. Sequence numbers of the foregoing processes do not mean execution sequences in embodiments of this application. The execution sequences of the processes should be determined based on functions and internal logic of the processes, and should not constitute any limitation on the implementation processes of embodiments of this application.

It may be understood that an “embodiment” mentioned throughout this specification means that particular features, structures, or characteristics related to the embodiment are included in at least one embodiment of this application.

Therefore, embodiments throughout the specification do not necessarily refer to a same embodiment. In addition, these particular features, structures, or characteristics may be combined in one or more embodiments in any appropriate manner. It may be understood that sequence numbers of processes do not mean execution sequences in embodiments of this application. The execution sequences of the processes should be determined based on functions and internal logic of the processes, and should not constitute any limitation on implementation processes of embodiments of this application.

A person of ordinary skill in the art may be aware that in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that for the purpose of convenient and brief description, for detailed working processes of the foregoing system, apparatus, and unit, refer to a corresponding process in the foregoing method embodiments. Details are not described herein again. In several embodiments provided in this application, it should be understood that the disclosed system, apparatus, and method may be implemented in other manners. For example, the foregoing described apparatus embodiments are merely examples. For example, division into the units is merely logical function division and may be another division manner during actual implementation. For example, a plurality of units or components may be combined or integrated into another system, or some features may be ignored or not performed.

In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, in other words, may be located in one position, or may be distributed on a plurality of network units. Some or all of the units may be selected based on an actual requirement to achieve the objectives of the solutions of embodiments. In addition, functional units in embodiments of this application may be integrated into one processing unit, each of the units may exist alone physically, or two or more units are integrated into one unit.

When functions are implemented in a form of a software functional unit and sold or used as an independent product, the functions may be stored in a computer-readable storage medium. Based on such an understanding, the technical solutions of embodiments of this application essentially, or the part contributing to a conventional technology, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a ROM, a RAM, a magnetic disk, or an optical disc.

The foregoing descriptions are merely specific implementations of embodiments of this application, but are not intended to limit the protection scope of embodiments of this application. Any variation or replacement readily figured out by a person skilled in the art within the technical scope disclosed in embodiments of this application shall fall within the protection scope of embodiments of this application. Therefore, the protection scope of embodiments of this application should be subject to the protection scope of the claims.

1. A communication method, comprising:
receiving, by a first communication apparatus, first configuration information of a first cell of a second communication apparatus, wherein the first configuration information comprises first identification update information and information about a first update moment of the first cell, and the first identification update information is used to determine first identification information used by the first cell at the first update moment or after the first update moment; and
performing, by the first communication apparatus, communication based on the first configuration information by using the first identification information at the first update moment or after the first update moment, wherein the first communication apparatus is in a coverage range of the first cell.

2. A communication method, comprising:
determining, by a second communication apparatus, first configuration information of a first cell of the second communication apparatus, wherein the first configuration information comprises first identification update information and information about a first update moment of the first cell, and the first identification update information is used to determine first identification information used by the first cell at the first update moment or after the first update moment; and
sending, by the second communication apparatus, the first configuration information.

3. The method according to claim 2, wherein the sending, by the second communication apparatus, the first configuration information comprises:
sending, by the second communication apparatus, the first configuration information to a first communication apparatus in a coverage range of the first cell; or
sending, by the second communication apparatus, the first configuration information to a third communication apparatus corresponding to a second cell, wherein the second cell is a neighboring cell of the first cell.

4. The method according to claim 3, wherein the method further comprises:
receiving, by the second communication apparatus, second configuration information sent by the third communication apparatus corresponding to the second cell, wherein the second configuration information comprises second identification update information and information about a second update moment of the second cell, and the second identification update information is used to determine second identification information used by the second cell at the second update moment or after the second update moment; and
sending, by the second communication apparatus, the second configuration information to the first communication apparatus.

5. The method according to claim 1, wherein the first identification information comprises a physical cell identifier.

6. The method according to claim 5, wherein the first identification information further comprises at least one of a frequency or a polarization direction.

7. The method according to claim 1, wherein the first identification update information comprises:
the first identification information, or a difference between the first identification information and identification information that is used by the first cell before the first update moment.

8. The method according to claim 1, wherein the information about the first update moment comprises timer information corresponding to the first update moment or standard time corresponding to the first update moment.

9. The method according to claim 1, wherein the first configuration information further comprises:
third identification update information and information about a third update moment of the first cell, wherein the third identification update information is used to determine third identification information used by the first cell at the third update moment or after the third update moment.

10. The method according to claim 3, wherein:
the second cell is a first-order neighboring cell of the first cell; or
the second cell is a second-order neighboring cell of the first cell.

11. A communication apparatus, comprising:
a receiver, the receiver configured to receive first configuration information of a first cell of a second communication apparatus, wherein the first configuration information comprises first identification update information and information about a first update moment of the first cell, and the first identification update information is used to determine first identification information used by the first cell at the first update moment or after the first update moment;
at least one processor; and
at least one memory coupled to the at least one processor and storing programming instructions for execution by the at least one processor to communicate based on the first configuration information by using the first identification information at the first update moment or after the first update moment, wherein the communication apparatus is in a coverage range of the first cell.

12. A communication apparatus, comprising:
at least one processor;
at least one memory coupled to the at least one processor and storing programming instructions for execution by the at least one processor to determine first configuration information of a first cell of the communication apparatus, wherein the first configuration information comprises first identification update information and information about a first update moment of the first cell, and the first identification update information is used to determine first identification information used by the first cell at the first update moment or after the first update moment; and
a transceiver, the transceiver configured to send the first configuration information.

13. The apparatus according to claim 12, wherein:
the transceiver is configured to send the first configuration information to a first communication apparatus in a coverage range of the first cell; or
the transceiver is configured to send the first configuration information to a third communication apparatus corresponding to a second cell, wherein the second cell is a neighboring cell of the first cell.

14. The apparatus according to claim 13, wherein:
the transceiver is further configured to receive second configuration information sent by the third communication apparatus corresponding to the second cell, wherein the second configuration information comprises second identification update information and information about a second update moment of the second cell, and the second identification update information is used to determine second identification information used by the second cell at the second update moment or after the second update moment; and
the transceiver is further configured to send the second configuration information to the first communication apparatus.

15. The apparatus according to claim 11, wherein the first identification information comprises a physical cell identifier.

16. The apparatus according to claim 15, wherein the first identification information further comprises at least one of a frequency and a polarization direction.

17. The apparatus according to claim 11, wherein the first identification update information comprises:
the first identification information, or a difference between the first identification information and identification information that is used by the first cell before the first update moment.

18. The apparatus according to claim 11, wherein the information about the first update moment comprises timer information corresponding to the first update moment or standard time corresponding to the first update moment.

19. The apparatus according to claim 11, wherein the first configuration information further comprises:
third identification update information and information about a third update moment of the first cell, wherein the third identification update information is used to determine third identification information used by the first cell at the third update moment or after the third update moment.

20. The apparatus according to claim 13, wherein:
the second cell is a first-order neighboring cell of the first cell; or
the second cell is a second-order neighboring cell of the first cell.
